(19) United States
(12) Patent Application Publication
(10) Pub. No.: US 2012/0191326 A1
(43) Pub. Date: Jul. 26, 2012

(54) Control Device for Internal Combustion Engine and Internal Combustion Engine

(75) Inventors: Yoshihiro SUKEGAWA, Hitachi (JP); Tomoyuki Murakami, Isesaki (JP); Masayuki Saruwatari, Isesaki (JP); Kosuke Kanda, Isesaki (JP)

(73) Assignee: Hitachi Automotive Systems, Ltd., Hitachinaka-shi (JP)

(21) Appl. No.: 13/355,847

(22) Filed: Jan. 23, 2012

(30) Foreign Application Priority Data
Jan. 24, 2011 (JP) 2011-012294

(51) Int. Cl. F02D 41/26

(52) U.S. Cl. 701/105

(57) ABSTRACT

A control device for an internal combustion engine that is capable of easily switching between a stratified operation mode and a non-stratified operation mode is provided for a port injection spark ignition internal combustion engine. Injection directions in which sprayed fuel is injected from a fuel injection valve are defined nearer the center of a cylinder than the centers of two intake valves. Injection timing of the fuel injection valve is controlled by the stratified operation mode completing the fuel injection in the exhaust stroke, and the non-stratified operation mode completing the fuel injection in a range from a compression stroke to the exhaust stroke. The injection end timing of the fuel injection valve in the stratified operation mode is retarded from the injection end timing in the non-stratified operation mode, in which the fuel injection time is equal to or shorter than that in the stratified operation mode.

### BACKGROUND OF THE INVENTION

1. Field of the Invention

The present invention relates to a control device for an internal combustion engine and an internal combustion engine, and particularly to a control device for an internal combustion engine and an internal combustion engine which are capable of easily switching between stratified combustion and homogeneous combustion.

2. Background Art

It has been known that a spark-ignition internal combustion engine has a homogeneous operation mode for combusting air-fuel mixture with homogeneous fuel density, and a stratified operation mode for combusting air-fuel mixture in which the fuel density around a spark plug is higher than the other areas. The homogeneous combustion mode has characteristics in that incomplete combustion and soot exhaust are small because combustion is made in a state where fuel and air are well mixed. On the other hand, the stratified combustion mode has characteristics which reduce cycle variation owing to failed ignition of fuel and poor initial flame propagation because the mixture is well ignited and initial flame propagation velocity is high. Accordingly, when lean mixture or mixture diluted with a large amount of exhaust gas recirculation (EGR) gas is stably combusted, the stratified combustion mode is used. It has been known that, in the spark-ignition internal combustion engine, the ignition timing is retarded even to the early part of an expansion stroke in order to rapidly activate a catalyst immediately after cold start. The stratified operation mode is used also when the ignition timing is retarded in order to stabilize combustion. The homogeneous operation mode and the stratified operation mode thus have different characteristics. Accordingly, it is preferable that the operation mode of the internal combustion engine be switched between the homogeneous operation mode and the stratified operation mode responsive to a required operation state.

For instance, JP Patent Publication (Kokai) No. 2009-216004A (2009) discloses a conventional technique of switching between the homogeneous operation mode and the stratified operation mode in a port injection spark ignition internal combustion engine. This conventional technique sets the injection directions such that sprayed fuel injected from two fuel injection valves provided at respective two intake ports intersect with each other in a combustion chamber, and the fuel is injected before an intake stroke in a case where the combustion pattern is the homogeneous combustion, and the fuel is injected in an intake stroke in a case where the combustion pattern is the stratified combustion. Accordingly, in an intake stroke, cones of sprayed fuel injected from the two fuel injection valves collide with each other in the combustion chamber, the fuel is granulated, and diffusion of fuel to the combustion chamber is prevented, thereby allowing stratified mixture to be formed in the combustion chamber.

JP Patent Publication (Kokai) No. 6-108951A (1994) discloses another conventional technique of forming stratified mixture in a port injection spark ignition internal combustion engine. This conventional technique provides a wall which divides a path into a path on an ignition means side and a path on the side opposite to the ignition means in an intake port; the wall is formed so as to cover the substantially entire area of the intake port upstream from the stem of an intake valve. The wall is thus provided in the intake port, thereby allowing stratified mixture to be formed in the combustion chamber irrespective of operation conditions.

Incidentally, when fuel is injected in an intake stroke, a lot of sprayed fuel directly flows into the combustion chamber through an opening of an intake valve. Sprayed fuel typically includes droplets with various diameters. Accordingly, when the fuel is injected in an intake stroke, droplets with relatively large diameters also flow into the combustion chamber directly. Since the droplets with large diameter have large inertial force, the droplets easily collide with a wall surface of the combustion chamber to form a liquid film. The fuel as the liquid film on the wall surface of the combustion chamber is difficult to be vaporized. Accordingly, there is a high possibility that resultant unburned HC and soot are exhausted. The internal combustion engine disclosed in JP Patent Publication (Kokai) No. 2009-216004A (2009) can reduce the droplets reaching the wall surface of the combustion chamber by colliding the cones of sprayed fuel with each other in the combustion chamber. However, this causes a problem in that the droplets secondarily dispersed by the collision adhere to the wall surface. Further, since the cones of sprayed fuel are collide with each other in the combustion chamber, fuel injection directions are required to be correctly defined. This causes a problem that imposes strict manufacturing tolerances. Moreover, when the fuel is injected in the intake stroke, the motion of the sprayed fuel is susceptible to a gas flow caused in the intake stroke. This causes another problem that reduces robustness of the internal combustion engine to the number of revolutions and load.

The internal combustion engine disclosed in JP Patent Publication (Kokai) No. 6-108951A (1994) can always form the stratified mixture irrespective of operation conditions. However, with this engine, the aforementioned advantages of homogeneous mixture cannot be enjoyed. Further, problems are caused in that the wall provided in the intake port reduces the flow rate coefficient of the intake port and thereby reduces the output of the internal combustion engine and in that man-hours for manufacturing internal combustion engines is increased.

### SUMMARY OF THE INVENTION

The present invention is made in view of the problems. It is an object of the present invention to provide a control device for an internal combustion engine and an internal combustion engine which are capable of easily switching between a stratified operation mode and a non-stratified operation mode (homogeneous operation mode) while suppressing reduction in performance of the internal combustion engine.

In order to solve the above problems, a control device for an internal combustion engine is a control device for an internal combustion engine, the engine comprising: a cylinder including two intake openings; two intake paths which are connected to the cylinder and communicate with a combustion chamber of the cylinder through the respective two intake openings; two intake valves which are arranged in the respective two intake paths and open and close the intake openings; and at least one fuel injection valve for injecting fuel in the two intake paths, wherein the fuel injection valve is arranged such that injection directions of injected sprayed fuel are disposed nearer a midpoint of a line segment connecting centers of the two intake valves than the centers of two intake valves, respectively.

According to the above mode, the fuel is injected from the fuel injection valve in the exhaust stroke toward directions nearer the midpoint of a line segment connecting the centers of the two intake valves than the centers of the intake valves, thereby allowing a lot of fuel droplets to be suspended around the surfaces of areas of the intake valves which are near the center of the cylinder. Here, in a case where time from the injection end timing to the intake top dead center is long, the suspended droplets are dispersed over the entire surfaces. In this state, when the intake valves are opened to start the intake stroke, the fuel droplets are evenly dispersed in the combustion chamber, thereby forming homogeneous mixture. On the other hand, in a case where the injection end timing is retarded to shorten the time from injection end timing to the intake top dead center, the intake stroke is started before the suspended droplets have not been dispersed over the entire surfaces of the intake valves yet, and a lot of fuel droplets flow into the combustion chamber from areas of openings of the intake valves which are near the center of the cylinder, thereby forming stratified mixture. The fuel is thus injected before the intake stroke is started. Accordingly, droplets with larger particle diameters adhere to the intake valves, and droplets with smaller particle diameters selectively flow into the intake stroke. This can suppress adhesion of fuel to the wall surface of the combustion chamber which is to be a cause of emitting unburned HC and soot.

As can be understood by the above description, the present invention can easily switch between formation of homogeneous mixture and formation of stratified mixture by means of fuel injection timing. This negates the need of additional wall and the like in the intake port, and can suppress reduction in output of the internal combustion engine and fuel consumption efficiency, and can also suppress increase in man-hours for manufacturing the internal combustion engine.

Problems, configurations and advantageous effects other than those described above will become apparent from after-mentioned embodiments to be described below.

### BRIEF DESCRIPTION OF THE DRAWINGS

FIG. 1 is a longitudinal sectional view of an entire internal combustion engine to which Embodiment 1 of a control device for an internal combustion engine according to the present invention is applied.

FIG. 2 is an enlarged plan view of the top of a fuel injection part of the internal combustion engine shown in FIG. 1.

FIG. 3 is a diagram showing injection directions of fuel injection valves shown in FIG. 2.

FIG. 4A is a diagram showing a definition of the sprayed fuel injected from the fuel injection valve shown in FIG. 2.

FIG. 4B is a contour map illustrating a distribution of a flow rate flux for a sprayed fuel form.

FIG. 4C is a contour map illustrating a distribution of a flow rate flux for a sprayed fuel form.

FIG. 4D is a contour map illustrating a distribution of a flow rate flux for a sprayed fuel form.

FIG. 5 is a diagram showing a relationship between a cycle of the internal combustion engine shown in FIG. 1 and valve opening timings of intake valves and exhaust valves.

FIG. 6 is a diagram showing a control flow after a start of the internal combustion engine shown in FIG. 1.

FIG. 7 is a diagram showing transition of control operation based on the control flow shown in FIG. 6 in a time series manner.

FIG. 8A is a diagram showing a fuel injection timing and a fuel ignition timing in the warm-up mode (stratified operation mode) based on the control flow shown in FIG. 6.

FIG. 8B is a diagram showing a fuel injection timing and a fuel ignition timing after the end of the warm-up mode (non-stratified operation mode) based on the control flow shown in FIG. 6.

FIG. 9A is a diagram showing a sprayed fuel form at the intake top dead center in the warm-up mode (stratified operation mode) in Embodiment 1.

FIG. 9B is a diagram showing a sprayed fuel form in an early part of the intake stroke in the warm-up mode (stratified operation mode) in Embodiment 1.

FIG. 10 is a schematic diagram showing the sprayed fuel forms shown in FIG. 9A as viewed from the exhaust side.

FIG. 11 is a perspective view schematically showing air flow in a combustion chamber in strokes from the intake stroke to the compression stroke in the internal combustion engine shown in FIG. 1.

FIG. 12 is a perspective view schematically showing distributions of mixture in the combustion chamber at the fuel ignition timing in the warm-up mode (stratified operation mode) in the internal combustion engine shown in FIG. 1.

FIG. 13A shows a sprayed fuel form in an intermediate time between the end of the fuel injection and the intake top dead center after the end of the warm-up mode (non-stratified operation mode) in Embodiment 1.

FIG. 13B shows a sprayed fuel faun at the intake top dead center after the end of the warm-up mode (non-stratified operation mode) in Embodiment 1.

FIG. 13C shows a sprayed fuel form in an early part of the intake stroke after the end of the warm-up mode (non-stratified operation mode) in Embodiment 1.

FIG. 14 is a schematic diagram showing the sprayed fuel forms shown in FIG. 13A as viewed from an exhaust side.

FIG. 15 is a schematic diagram showing air flows around the intake valves in FIG. 13B.

FIG. 16 is a diagram showing a relationship between the Stokes number and the wall surface adhesion ratio of fuel.

FIG. 17 is a diagram showing a relationship between the fuel injection velocity and the Sauter mean diameter in a case where the Stokes number is one.

FIG. 18 is a longitudinal sectional view showing a shape of a nozzle tip of a fuel injection valve suitable for Embodiment 1.

FIG. 19 is a B-B arrow view of FIG. 18 and illustrates an orifice plate and fuel flow.

FIG. 20 is a longitudinal sectional view illustrating a liquid film injected from a nozzle port shown in FIG. 18.

FIG. 21 is an enlarged plan view of the top of a fuel injection part to which Embodiment 2 of a control device for an internal combustion engine according to the present invention is applied.

FIG. 22A is a diagram illustrating the central axes of cones of sprayed fuel. FIG. 22B is a contour map illustrating a distribution of the flow rate flux of sprayed fuel.

FIG. 22C is a diagram illustrating integration of the flow rate flux shown in FIG. 22B.

FIG. 23 is an enlarged plan view of the top of a fuel injection part to which Embodiment 3 of a control device for an internal combustion engine according to the present invention is applied.

FIG. 24 is a diagram illustrating a spray cone angle from fuel injection valve shown in FIG. 23.

FIG. 25 is a diagram illustrating setting of EGR rates for the number of revolutions and torques in an internal combustion engine to which Embodiment 4 of a control device for an internal combustion engine according to the present invention is applied.

FIG. 26 is a control flow diagram in an EGR operation in Embodiment 4.

FIG. 27 is a diagram illustrating setting regions of the stratified operation mode and the non-stratified operation mode for the degree of opening of an EGR valve and the degree of opening of a throttle valve in Embodiment 4.

FIG. 28A is a diagram showing a fuel injection timing and a fuel ignition timing at the point A (non-stratified operation mode) shown in FIG. 27.

FIG. 28B is a diagram showing a fuel injection timing and a fuel ignition timing at the point B (stratified operation mode) shown in FIG. 27.

FIG. 29 is a diagram illustrating setting regions of the stratified operation mode and the non-stratified operation mode for the degree of opening of the EGR valve and the degree of opening of the throttle valve in Embodiment 4.

FIG. 30A is a diagram showing a fuel injection timing and a fuel ignition timing at the point C (non-stratified operation mode) shown in FIG. 29.

FIG. 30B is a diagram showing a fuel injection timing and a fuel ignition timing at the point D (stratified operation mode) shown in FIG. 29.

FIG. 30C is a diagram showing a fuel injection timing and a fuel ignition timing at the point E (non-stratified operation mode) shown in FIG. 29.

FIG. 31A is a diagram showing opening and closing timings of the intake valves and the exhaust valves which are suitable for the stratified operation mode.

FIG. 31B is a diagram showing opening and closing timings of the intake valves and the exhaust valves which are suitable for the non-stratified operation mode.

### DETAILED DESCRIPTION OF THE PREFERRED EMBODIMENTS

Embodiments of a control device for an internal combustion engine according to the present invention will hereinafter be described with reference to drawings.

### Embodiment 1

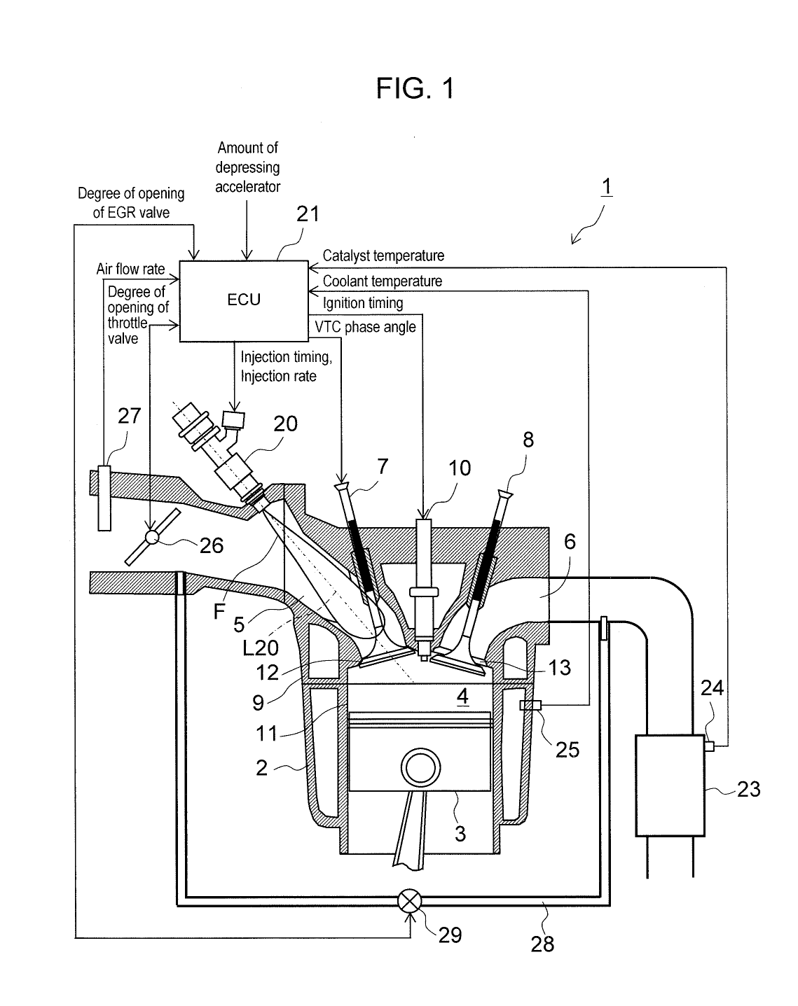

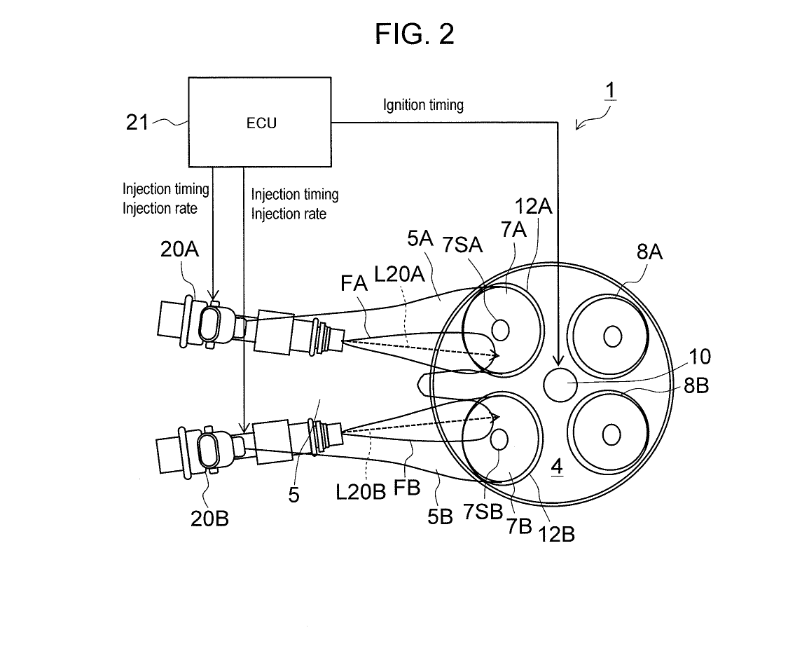

First, referring to FIGS. 1 to 22, Embodiment 1 of the control device for an internal combustion engine according to the present invention will be described in detail. FIGS. 1 and 2 show a fundamental configuration of an internal combustion engine to which the Embodiment 1 is applied. FIG. 1 is a longitudinal sectional view of the entire internal combustion engine. FIG. 2 is a schematic enlarged plan view of the top of a fuel injection part of the internal combustion engine. Note that, in following Embodiments 1 to 4, description will be made using one selected cylinder included in the internal combustion engine. However, these embodiments are applicable both to single cylinder and multi-cylinder internal combustion engines.

The internal combustion engine 1 shown in FIG. 1 includes a cylinder block 2, a cylinder head 9, and a piston 3 inserted into the cylinder block 2. The cylinder block 2 and the cylinder head 9 define a cylinder 11 of the internal combustion engine 1, forming a combustion chamber 4 in the cylinder 11. Further, an intake port 5 and an exhaust port 6 are formed. The intake port 5 and the exhaust port 6 are provided at the cylinder 11, and open at the combustion chamber 4 via intake openings 12 and exhaust openings 13 of the cylinder head 9 of the cylinder 11 to fluidly communicate with the combustion chamber 4. Further, two intake valves 7 and two exhaust valves 8 (see FIG. 2) for opening and closing the intake openings 12 and the exhaust openings 13 are arranged in the intake port 5 and the exhaust port 6 of the cylinder head 9, respectively. Valve opening timing and valve closing timing of the intake valves 7 can be changed by a variable timing control mechanism (VTC), not shown. Fuel F injected from a fuel injection valve 20 included in the internal combustion engine 1 into the intake port 5 in an injection direction L20 is supplied from the intake port 5 to the combustion chamber 4 through the intake openings 12 when the intake valves 7 are opened.

A throttle valve 26 for adjusting an air flow rate flowing into the combustion chamber 4 and an air flow meter 27 for detecting the air flow rate are provided upstream from the intake port 5. The exhaust port 6 and the intake port 5 communicate with each other by an EGR (Exhaust Gas Recirculation) tube 28. A part of exhaust gas from the exhaust port 6 is returned into the intake port 5 through the EGR tube 28. The flow rate of exhaust gas flowing through the EGR tube 28 is adjusted by the degree of opening of the EGR valve 29.

A catalytic converter 23 is provided downstream from the exhaust port 6. Here, the catalytic converter 23 is a ternary catalyst system where platinum or palladium is applied on a carrier such as alumina or ceria. In the catalyst, oxidation reaction of carbon monoxide (CO) and unburned hydrocarbon (HC) in exhaust gas and reduction reaction of nitrogen oxides (NOx) reduces the three hazardous components at the same time. A catalyst temperature is required to be at least the activation temperature (e.g. 250° C.) in order to allow the catalytic converter 23 to efficiently purify the exhaust gas.

An internal combustion engine control unit (ECU) 21 mainly includes a microcomputer and a read-only memory (ROM). This unit can performs an internal combustion engine control program stored in the ROM to thereby control the fuel injection timing and the fuel injection rate by the fuel injection valve 20, the ignition timing by the spark plug 10, the degree of opening of the throttle valve 26, the degree of opening of the EGR valve 29, the VTC phase angle and the like. The ECU 21 reads the coolant temperature of the internal combustion engine which has been detected by a coolant temperature sensor 25, the catalyst temperature detected by the catalyst temperature sensor 24, the air flow rate detected by the air flow meter 27, the amount of depressing an accelerator pedal, not shown, and the like. Read information thereof is utilized for controlling the fuel injection timing and the fuel injection rate by the fuel injection valve 20, the ignition timing by the spark plug 10, the degree of opening of the throttle valve 26, the degree of opening of the EGR valve 29, the VTC phase angle and the like.

As shown in FIG. 2, in Embodiment 1, the two fuel injection valves 20A and 20B are disposed at the intake port 5 which is upstream from the branched intake ports (intake paths) 5A and 5B and at which the branched intake ports 5A and 5B are integrated. The fuel injection valve 20A is disposed at a position capable of injecting fuel toward the intake valve 7A at the intake opening 12A. The fuel injection valve 20B is disposed at a position capable of injecting fuel toward the intake valve 7B at the intake opening 12B. The spark plug 10 is disposed at the top center of the combustion chamber 4. That is, an injection direction L20A in which sprayed fuel FA is injected from the fuel injection valve 20A is oriented in a direction towered the intake valve 7A. An injection direction L20B of sprayed fuel FB injected from the fuel injection valve 20B is oriented in a direction toward the intake valve 7B. The shapes and fuel injection pressures of nozzles of the fuel injection valves 20A and 20B are determined so as to sufficiently reduce the particle diameters of droplets of cones of the sprayed fuel FA and FB injected from the fuel injection valves 20A and 20B (e.g. such that the Sauter mean diameter SMD becomes about 20 μm). Intake valve stems 7SA and 7SB for allowing the intake valves 7A and 7B to move in the axial directions are provided at the center parts of the intake valves 7A and 7B, respectively. Exhaust valves 8A and 8B as many as the intake valves 7A and 7B are provided downstream from the intake valves 7A and 7B with respect to the fuel injection directions.

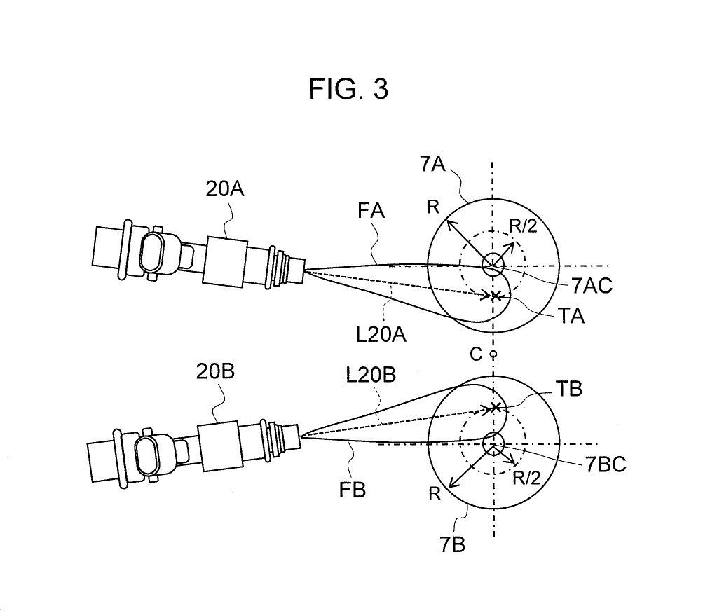

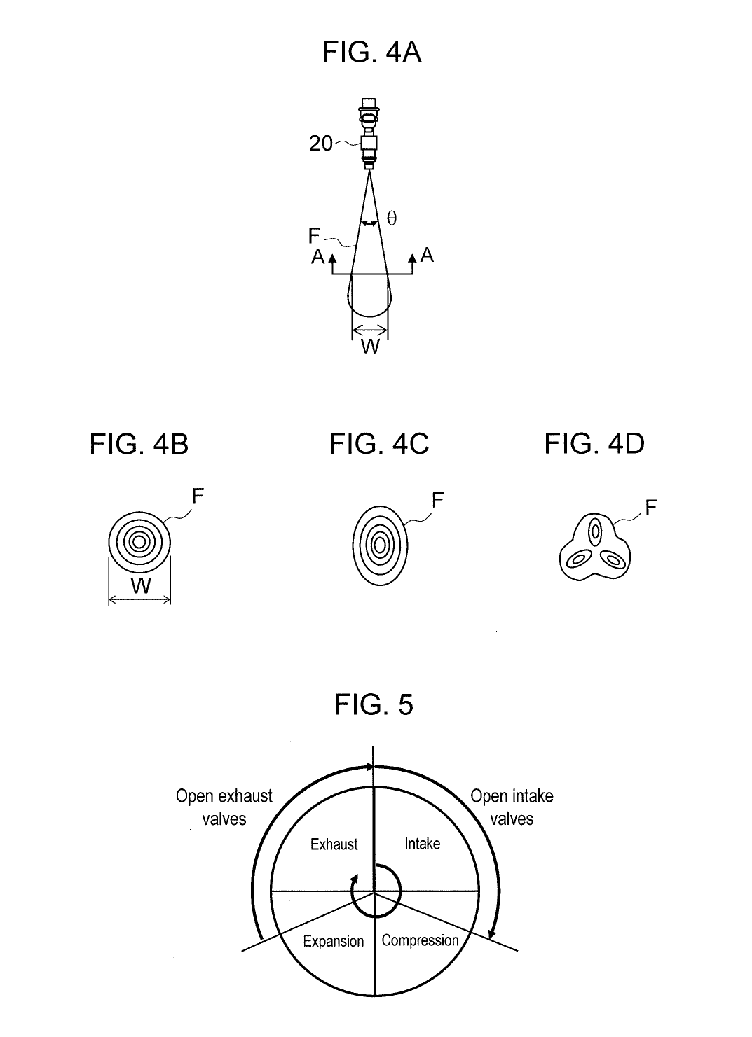

Next, referring to FIGS. 3 and 4, the injection directions of sprayed fuel injected by the fuel injection valves 20 and injection forms thereof will be described more specifically.

FIG. 3 is a diagram schematically showing a positional relationship between the two intake valves 7A and 7B and the cones of the sprayed fuel FA and FB injected from the two fuel injection valves 20A and 20B. In the Embodiment 1 shown, reference symbol C denote the midpoint of a line segment connecting the centers 7AC and 7BC of the two intake valves 7A and 7B. The fuel injection valve 20A is attached such that the central axis L20A of the sprayed fuel FA passes through a point TA shifted toward the midpoint C by about R/2 (R is the radius of the intake valve 7A) from the center of the intake valve 7A. The fuel injection valve 20B is attached such that the central axis L20B of the sprayed fuel FB passes through a point TB shifted toward the midpoint C by about R/2 (R is the radius of the intake valve 7B) from the center of the intake valve 7B. Note that, in a case where the fuel injection valves 20A and 20B are attached to the internal combustion engine 1 such that the injection directions L20A and L20B of the fuel injection valves 20A and 20B are shifted toward the midpoint C from the corresponding centers 7AC and 7BC of the intake valves 7A and 7B, respectively, advantageous effects equivalent to those described below can be achieved.

FIG. 4 shows examples of the sprayed fuel F injected from the fuel injection valve 20. FIG. 4A shows a definition of the sprayed fuel F injected from the fuel injection valve 20. FIGS. 4B to 4D show examples of distributions of fuel flow rate fluxes (fuel flow rate per unit area) of the sprayed fuel F which are arrow views taken along line A-A in FIG. 4A. Here, A-A section is disposed at the position of a section taken on the way of a length from the nozzle of the fuel injection valve 20 to the surface of the intake valve 7 in a case where the fuel injection valve 20 is attached to the internal combustion engine 1. For instance, this section is disposed 50 to 100 mm below the nozzle.

As shown in FIG. 4A, the sprayed fuel F is injected from the fuel injection valve 20 at a spray cone angle θ, and has a width W in the A-A section. FIG. 4B shows an example of the form of the sprayed fuel F. The flow rate reaches a local maximum at the center of the sprayed fuel F in the A-A section, and decreases to the outward sense in the radial direction from the center until the diameter W reaches. The sectional shape of the sprayed fuel in the A-A section is not limited to such a perfect circle. Instead, as shown in FIG. 4C, the sectional shape of the sprayed fuel may be an elliptical shape. Further, as shown in FIG. 4D, the shape may represent a distribution having a plurality of local maximum values of the flow rate in the spray section. Although not shown, as with a hollow cone spray, the spray form may be such that the flow rate flux at a center part of the sprayed fuel is smaller than that at circumferential part. It is preferable that the spray cone angle θ shown in FIG. 4A be defined such that the spray width W at the position of the intake valve is substantially identical to the radius R of the intake valve (see FIG. 3).

Here, the internal combustion engine 1 is a four-cycle engine as shown in FIG. 5, in which intake, compression, expansion and exhaust strokes are switched every 180° of crank angle. In typical operation conditions (e.g. light load conditions after completion of warming-up), the intake valves 7 open when the intake stroke starts, and close at the early part of the compression stroke. The exhaust valves 8 open at the latter part of the expansion stroke, and close at the latter part of the exhaust stroke.

In the internal combustion engine 1, the fuel F is mainly injected in the exhaust stroke, and the ignition typically performed at the latter part of the compression stroke. The fuel injection rate from the fuel injection valve 20 is adjusted by the injection time (Ti). That is, the fuel injection rate is in substantially proportion to Ti. When the fuel injection rate is low, Ti becomes shorter; when the fuel injection rate is high, Ti becomes longer. For instance, in cases of a high fuel injection rate, such as a case of full load operation, Ti is not accommodated within the exhaust stroke; there is a case where, although the start timing of injection from the fuel injection valve 20 is in the exhaust stroke, the injection end timing is in the intake stroke. The injection start timing is not necessarily limited within the exhaust stroke. Instead, there is a case of setting this timing in the compression stroke or the expansion stroke. In the case of thus setting the injection start timing in the compression or expansion stroke, a time period after injection of the fuel F to influx into the combustion chamber 4 becomes longer than the case of starting the fuel injection in the exhaust stroke. This allows vaporization and mixing of the fuel F in the intake port 5 to be facilitated.

Injection of the fuel F mainly in the exhaust stroke enables vaporization of the fuel F to be facilitated by means of heat of the intake valves 7. This prevents the sprayed fuel F from adhering to the inner wall surface of the combustion chamber 4. However, if the fuel F is injected in the intake stroke during which the intake valves 7 are opened, the sprayed fuel F directly flows into the combustion chamber 4 through the intake openings 12 of the intake valves 7, and the sprayed fuel F adheres to the inner wall surface of the combustion chamber 4. In particular, since droplets with relatively large diameters in the sprayed fuel F have high inertial force, these droplets easily adhere to the inner wall surface of the combustion chamber 4 if the fuel F is injected in the intake stroke. Further, if the fuel is injected in the intake stroke, the sprayed fuel F is accelerated by the flow of air into the combustion chamber 4 through the intake port 5. Accordingly, the fuel tends to adhere to the inner wall surface of the combustion chamber 4. This adhesion of the sprayed fuel F to the inner wall surface of the combustion chamber 4 causes possibilities that the amounts of unburned hydrocarbon (HC) and soot exhaust increase and that lubricating oil on the inner surface of the combustion chamber 4 is diluted by the fuel F to thereby seize up the piston 3.

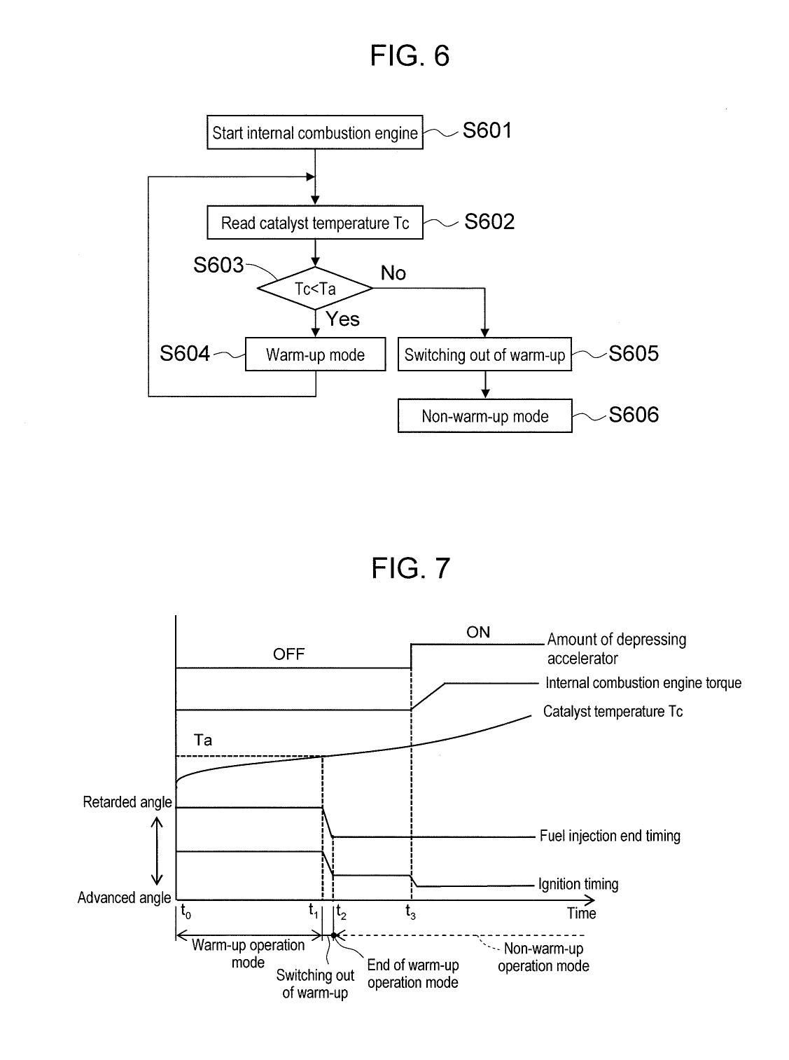

Next, referring to FIGS. 6 and 7, control sequence after starting the internal combustion engine 1 that is executed by the control program in the ECU 21 will be described.

FIG. 6 shows a control flow after starting the internal combustion engine 1 which is executed by the ECU 21. First, the internal combustion engine 1 is started (S601). The internal combustion engine 1 is started by a self-starting motor or the like rotating the crank shaft (not shown) of the internal combustion engine 1 at a prescribed rate and by injecting a prescribed amount of fuel F into the intake port 5. Next, the ECU 21 reads a catalyst temperature Tc from an output from the catalyst temperature sensor 24 (S602), and compares the catalyst temperature Tc with a predetermined temperature Ta (S603). Here, temperature Ta is for determining the activation state of the ternary catalyst, and set to for instance, to 250° C. If the catalyst temperature Tc is lower than Ta, the ECU 21 determines that the ternary catalyst has not been activated, the internal combustion engine 1 is operated in a warm-up mode (S604), and the processing returns to S602. If the catalyst temperature Tc is higher than Ta, the ECU 21 determines that the ternary catalyst has been activated, and performs switching out of warm-up (S605), and internal combustion engine 1 is operated thereafter in a non-warm-up mode (S606).

Note that, instead of the catalyst temperature Tc, a coolant temperature or an exhaust temperature of the internal combustion engine 1 may be used for determining whether the mode is the warm-up mode or not. For instance, if the coolant temperature or the exhaust temperature of the internal combustion engine 1 is lower than a predetermined temperature, it may be determined that the mode is the warm-up mode; if the coolant temperature or the exhaust temperature of the internal combustion engine 1 is higher than the predetermined temperature, the switching out of warm-up may be performed.

The determination of whether the mode is the warm-up mode or not may be determined using time elapsed from the start of the internal combustion engine 1. For instance, if the elapsed time is shorter than a predetermined prescribed time, the mode is set to the warm-up mode; if the elapsed time exceeds the predetermined prescribed time, switching out of warm-up may be performed. Here, the prescribed time may be determined on the basis of the coolant temperature or the intake temperature when the internal combustion engine 1 is started.

FIG. 7 shows an example of an amount of accelerating operation (depressing) from the start of the internal combustion engine 1 to the non-warm-up mode, a state of the internal combustion engine 1 according to the accelerating operation, and transition of the control operation based on the control flow shown in FIG. 6.

In this Embodiment 1, referring to FIG. 7, an operation state of the internal combustion engine 1 is assumed in a case where the internal combustion engine 1 is started at a time t₀, the accelerator is not depressed (accelerator is OFF) from the time t₀ to a time t₃, and the accelerator is depressed to a certain amount (accelerator ON) at the time t₃; an example of temporal transition of the internal combustion engine torque, the catalyst temperature Tc, the fuel injection end timing, and the ignition timing of the fuel in this state will be described.

From the time t₀ to the time t₁, where the catalyst temperature Tc is lower than the activation determination temperature Ta, the internal combustion engine 1 is operated in the warm-up mode. From the time t₁ to the time t₂, where the catalyst temperature Tc is above the activation determination temperature Ta, the internal combustion engine 1 performs switching out of warm-up, and the warm-up mode is finishes at the time t₂. Accordingly, after the time t₂, the internal combustion engine 1 is operated in the non-warm-up mode.

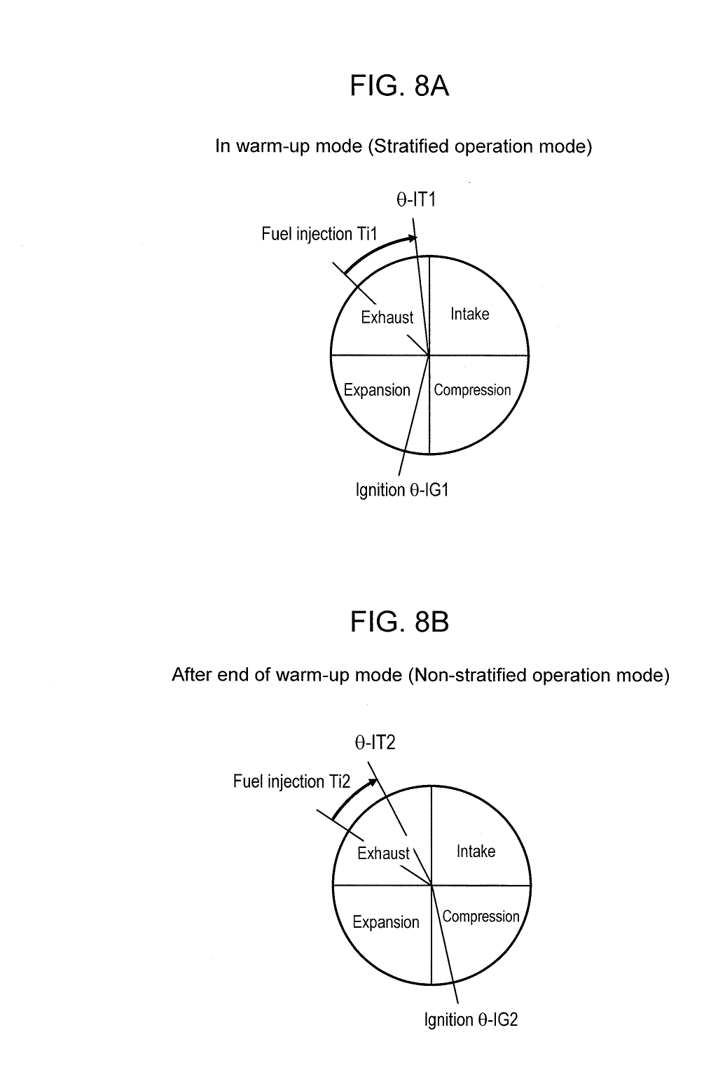

FIG. 8 shows a fuel injection timing and a fuel ignition timing in the warm-up mode (time t₀ to tᵢ) and after the end of the warm-up mode (time t₂) based on the control flow shown in FIG. 6. FIG. 8A is a diagram showing the fuel injection timing and the fuel ignition timing in the warm-up mode. FIG. 8B shows the fuel injection timing and the fuel ignition timing after the end of the warm-up mode. As will be described later, the warm-up mode may be referred to as a stratified operation mode, and the mode after the end of the warm-up mode may be referred to as a non-stratified operation mode.

In the warm-up mode (time t₀ to t₁) shown in FIG. 8A, the injection end timing θ-IT1 of fuel injection Ti1 is set in a latter part of the exhaust stroke (e.g. 10° before the intake top dead center). The ignition timing θ-IG1 in the warm-up mode is set at a timing after the top dead center of the compression stroke (e.g. 10° after the compression top dead center). Thus, in the warm-up mode, the ignition timing is set to the timing after the top dead center of the compression stroke. Accordingly, timing of generating heat by combustion is retarded, thereby enabling the exhaust temperature to be increased. This rapidly increases the temperature of the catalyst, thereby allowing emission of the exhaust hazardous components immediately after a cold start to be suppressed.

At the end of the warn-up mode (time t₂) shown in FIG. 8B, the injection end timing θ-IT2 of the fuel injection Ti2 is set at an angle (e.g. 90° before the intake top dead center) in the exhaust stroke which is more advanced than the injection end timing θ-IT1 in the warm-up mode (time t₀ to t₁). The ignition timing θ-IG2 after the end of the warm-up mode is set at the minimum advance for best torque (MBT). The ignition timing θ-IG2 is typically in the latter part of the compression stroke. For instance, the timing is set 10° before the compression top dead center. Here, the fuel injection rate after the end of the warm-up mode is set such that the internal combustion engine torque is identical to that in the warm-up mode. The fuel injection end timing θ-IT2 after the end of the warm-up mode is not limited in the exhaust stroke. Instead, the timing may be in the compression stroke or the expansion stroke. It is apparent that the injection end timing θ-IT2 in this case is more advanced than the injection end timing θ-IT1 in the warm-up mode.

Here, in comparison between FIGS. 8A and 8B, the fuel injection time Ti2 after the end of the warm-up mode is shorter than the fuel injection time Ti1 in the warm-up mode. This is because, as described above, the internal combustion engine 1 is operated at MBT after the end of the warm-up mode and fuel consumption efficiency is more improved than that in the warm-up mode with the ignition timing of the angle more retarded than MBT and thus the required fuel injection rate is reduced and thereby the required amount of fuel injection is reduced.

At switching out of warm-up (time t₁ to t₂) between FIGS. 8A and 8B, the fuel injection end timing is smoothly advanced from θ-IT1 shown in FIG. 8A toward θ-IT2 shown in FIG. 8B; likewise, the ignition timing is also smoothly advanced from θ-IG1 toward θ-IG2. The fuel injection rate at the switching out of warm-up is appropriately adjusted according to variation in fuel injection timing and ignition timing so as to maintain the internal combustion engine torque in the warm-up mode. This adjustment can effectively prevent a torque step in transition from the warm-up mode to the end of the warm-up mode from being caused.

As described above, in this Embodiment 1, the fuel injection valves 20 and the injection directions L20 are set so as to orient the sprayed fuel F toward the inner areas of the respective two intake valves 7, and the injection end timing θ-IT1 of the fuel injection valves 20 in the warm-up mode is set in the exhaust stroke and at the angle more retarded than the injection end timing θ-IT2 of the fuel injection valves 20 after the end of the warm-up mode. Operations and advantageous effects by thus defining the directions of the fuel injection L20 and changing the injection timings between the warm-up mode and the mode after the end of the warm-up will hereinafter be described.

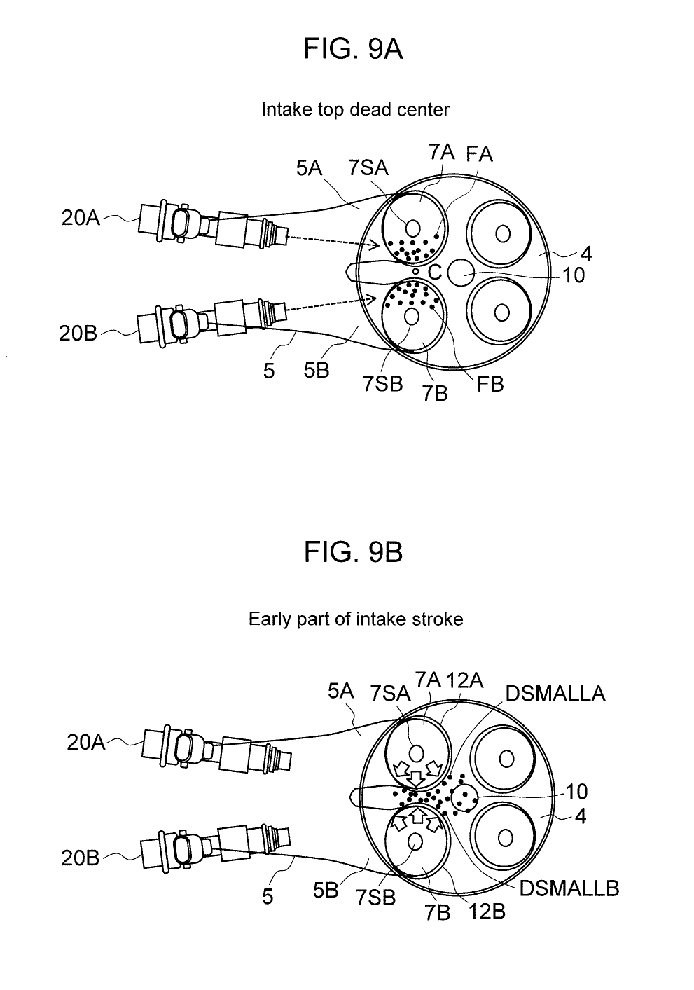

First, FIG. 9 shows sprayed fuel forms in the warm-up mode in Embodiment 1. FIG. 9A is a diagram showing the sprayed fuel forms at the intake top dead center. FIG. 9B is a diagram showing sprayed fuel forms the sprayed fuel form in the early part of the intake stroke.

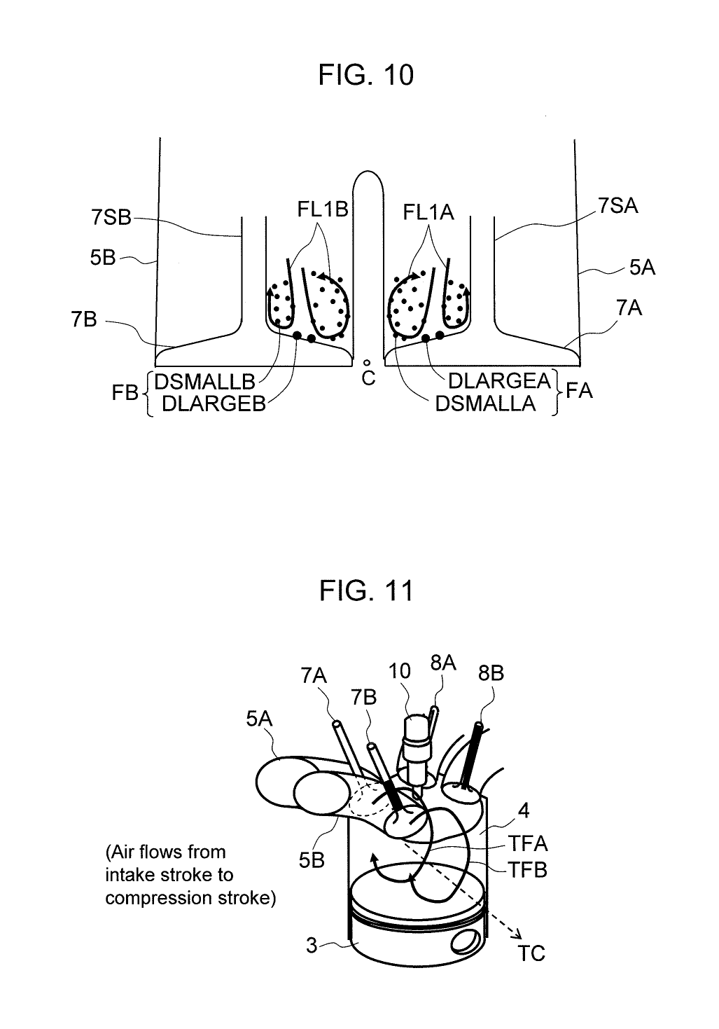

As shown in FIG. 9A, at the intake top dead center, cones of the sprayed fuel FA and FB injected from the fuel injection valves 20A and 20B pass through the branched intake ports 5A and 5B and travel toward areas (near the midpoint C) inner than the centers of the intake valves 7A and 7B (the centers of the intake valve stems 7SA and 7SB), respectively. In the warm-up mode, the end timing of the fuel injection θ-IT1 is set in the latter part of the exhaust stroke (see FIG. 8A). Accordingly, time from the end of injection to the intake top dead center is short, and the cones of sprayed fuel FA and FB have distributions biasing in respective inner portions of the intake valves 7A and 7B. As shown in FIG. 10, in view of the injection states in FIG. 9A from the exhaust side of the internal combustion engine 1, the particle diameters of the sprayed fuel FA and FB are small (e.g. Sauter mean diameter is 20 m). The injected sprayed fuel FA and FB is decelerated by resistance owing to air in the branched intake ports 5A and 5B. Since droplets DLARGEA and DLARGEB with larger diameters of the injected sprayed fuel FA and FB have high inertial forces, these droplets adhere to the surfaces of the intake valves 7A and 7B, respectively. On the other hand, since droplets DSMALLA and DSMALLB with smaller diameters have lower inertial forces, these droplets are suspended around the surfaces of the intake valves 7A and 7B in gas flows FL1A and FL1B swirled against the surfaces of the intake valves 7A and 7B without colliding with the intake valves 7A and 7B. Here, the gas flows FL1A and FL1B are air flows caused by friction between the sprayed fuel FA and FB and the branched intake ports 5A and 5B, respectively.

Next, as shown in FIG. 9B, in the early part of the intake stroke, droplets FA and FB suspended in a manner biasing the inner areas of the intake valves 7A and 7B shown in FIG. 9A flow into the combustion chamber 4 through inner openings inside the intake valves 7A and 7B in the intake openings 12A and 12B, respectively. As described above, since the droplets DLARGEA and DLARGEB of the sprayed fuel FA and FB that have larger diameters adhere to the surface of the intake valves 7A and 7B, respectively, these droplets do not flow into the combustion chamber 4. Instead, the droplets DSMALLA and DSMALLB that have lower inertial forces and small particle diameters flow into the combustion chamber 4. As a result, the droplets flowing into the combustion chamber 4 are hard to adhere to the wall surface of the combustion chamber 4. On the other hand, as shown in FIG. 9A, since no fuel droplet exists in outer parts of the intake valves 7A and 7B, there is almost no droplet that flows into the combustion chamber 4 through the openings outside the intake valves 7A and 7B in the respective intake openings 12A and 12B. As a result, in the early part of the intake stroke, a lot of fuel droplets exist in a manner biasing to the center of the combustion chamber 4 (adjacent to the spark plug 10).

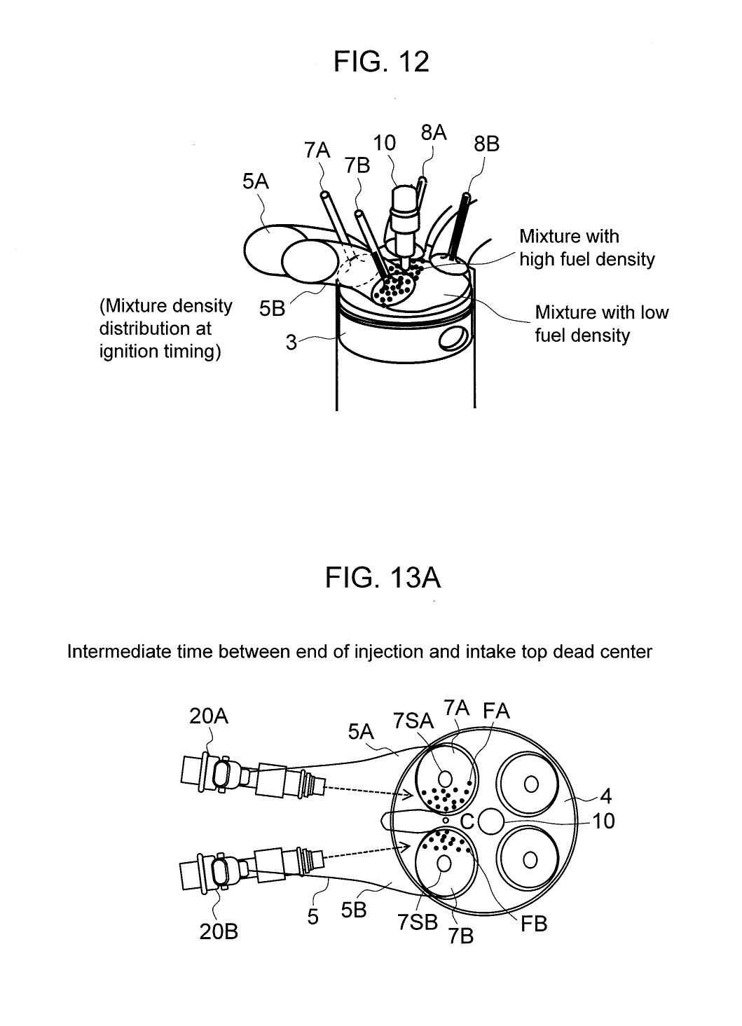

FIG. 11 shows typical air flows in the combustion chamber 4 in strokes from the intake stroke to the compression stroke. As shown in this diagram, in the combustion chamber 4, air flows from the openings of the intake valves 7A and 7B cause vertical swirls (also referred to as tumble flows) TFA and TFB. The vertical swirls TFA and TFB have little gas velocity components along the direction of the rotation axis TC. Accordingly, the sprayed fuel gathered around the center of the combustion chamber 4 and fuel vapor vaporized from the sprayed fuel are hardly dispersed in the outward direction of the combustion chamber 4 (the direction of the rotation axis TC of the vertical swirls), and accumulated in a central part of the combustion chamber 4 even in the latter part of the compression stroke. Accordingly, as shown in FIG. 12, even in the early part of the expansion stroke (the stroke after the compression stroke), which is the ignition timing in the warm-up mode, the fuel density around the spark plug 10 is higher than that in the other parts, thus forming so-called stratified mixture. This enables ignition performance for the mixture to be improved, and allows stable combustion with a small cycle variation even when the ignition timing is retarded to the early part of the expansion stroke. As described above, the fuel is hard to adhere to the wall surface to the combustion chamber 4. This allows emission unburned HC and soot to be efficiently suppressed.

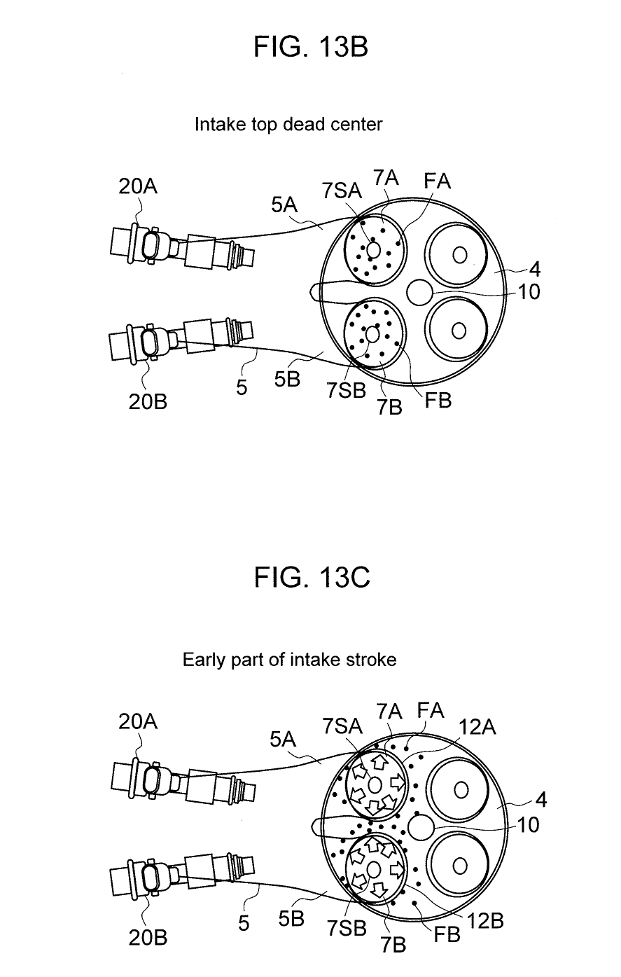

In contrast to the warm-up mode shown in FIG. 9, FIG. 13 shows sprayed fuel forms after the end of the warm-up mode in Embodiment 1. FIG. 13A shows the sprayed fuel forms in an intermediate time between the end of the fuel injection and the intake top dead center. FIG. 13B shows sprayed fuel forms at the intake stroke top dead center. FIG. 13C shows the sprayed fuel forms in the early part of the intake stroke.

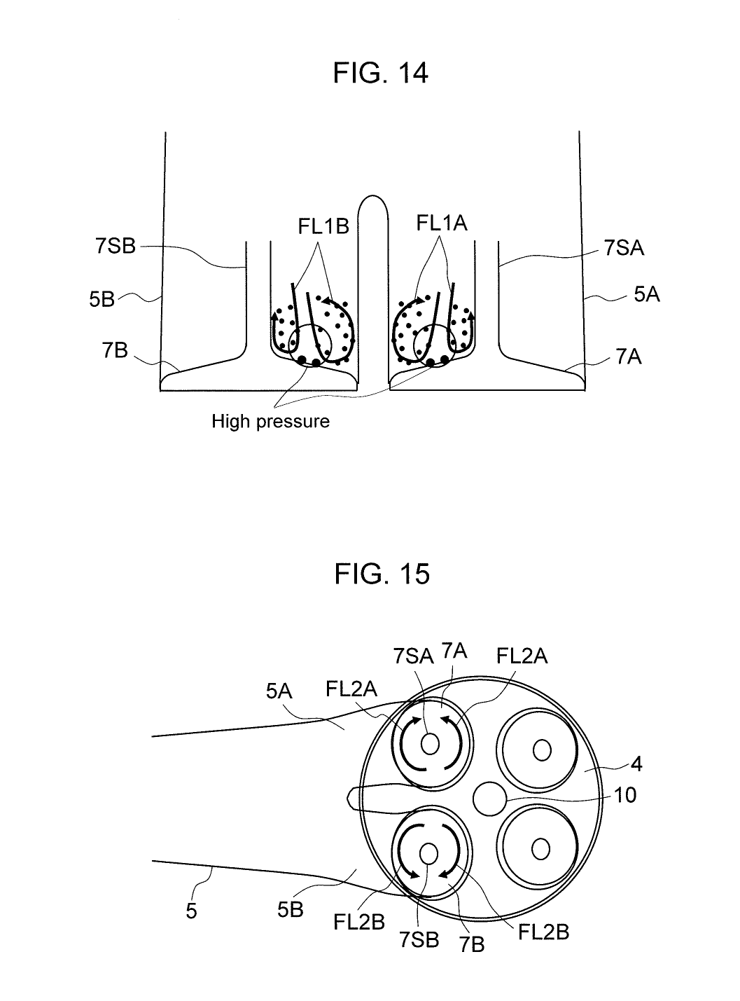

As shown in FIG. 13A, at and around the intermediate time between the end of the injection and the intake top dead center, the cones of the sprayed fuel FA and FB injected from the fuel injection valves 20A and 20B pass through the branched intake ports 5A and 5B, and travel toward areas of the intake valves 7A and 7B which are inner (toward the midpoint C) than the centers of the intake valves 7A and 7B (the center of the intake valve stems 7SA and 7SB). Accordingly, the cones of the sprayed fuel FA and FB have biased distributions in inner areas of the intake valves 7A and 7B. As with the case in the warm-up mode, sprayed fuel including droplets with small diameters are suspended around the surfaces of the intake valves 7A and 7B without adhering to the surfaces of the intake valves 7A and 7B. After the end of the warm-up mode, the timing of end of the fuel injection is set to an angle more advanced than that in the warm-up mode (see FIG. 8B). Accordingly, the time after the end of the injection to the intake top dead center is longer than that in the warm-up mode. Therefore, as shown in FIG. 13B, at the intake top dead center, the fuel droplets biasedly suspended in the inner areas of the intake valves 7A and 7B are dispersed over the entire surfaces of the intake valves 7A and 7B. That is, as shown in FIG. 14, in view of the injection state in FIG. 13A from the exhaust side of the internal combustion engine 1, the gas flows FL1A and FL1B caused by injection collide with the surfaces of the intake valves 7A and 7B, respectively. This increases gas pressures at collision areas. FIG. 15 shows gas flows on the respective surfaces of the intake valves 7A and 7B at and around the intake top dead center shown in FIG. 13B. As described above, as gas pressures in the inner area of the intake valves 7A and 7B increase, flows FL2A and FL2B are thereby generated from the inside to the outside of the intake valves 7A and 7B, respectively. These flows FL2A and FL2B convey fuel droplets FA and FB suspended inside the intake valves 7A and 7B, along the surfaces intake valves 7A and 7B to the outside the intake valves 7A and 7B, respectively. Accordingly, the fuel droplets are dispersed over the entire surfaces of the intake valves 7A and 7B at the intake top dead center.

Next, as shown in FIG. 13C, in the early part of the intake stroke, droplets FA and FB suspended at and around the surfaces of the intake valves 7A and 7B evenly flow into the combustion chamber 4 from the intake openings 12A and 12B, at which the intake valves 7A and 7B are opened. Thus, the sprayed fuel FA and FB evenly enter into the combustion chamber 4. Accordingly, in the latter part of the compression stroke where ignition is performed, non-stratified mixture having a fuel density with small unevenness is formed in the combustion chamber 4. In the non-stratified mixture, fuel and air (oxygen) are favorably mixed in comparison with the stratified mixture. This reduces the amount of unburned fuel, and allows highly efficient combustion. Further, local fuel richness is not caused, which suppresses emission of soot and unburned HC and knocking.

As described above, in this Embodiment 1, in the warm-up mode, before the fuel droplets suspended around the inner surfaces of the intake valves 7A and 7B have been dispersed, the intake is performed. This allows the stratified mixture to be formed around the spark plug 10. Further, in the mode after the end of the warm-up mode, after the fuel droplets suspended around the inner surfaces of the intake valves 7A and 7B have been dispersed over the intake valves 7A and 7B, the intake is performed. This allows the non-stratified mixture to be easily formed in the combustion chamber 4.

Incidentally, if a lot of fuel droplets injected into the intake port 5 adhere to the wall surfaces of the intake valve 7 and the intake port 5, it is difficult to switch between formation of the stratified mixture and formation of the non-stratified mixture by changing the injection timing as described above. This is because as follows. Since the traveling velocity of fuel adhering to the wall surface is significantly slow, the adhering fuel cannot be dispersed over the entire intake valve 7 even if the fuel injection timing is advanced; if the amount of fuel adhering to the wall surface is large, the droplets suspended around the surface of the intake valves 7 are reduced, thereby reducing the amount of fuel dispersed over the entire intake valves 7 even if the fuel injection timing is advanced. That is, in such cases, during the intake valve 7 is open, a lot of fuel exist in at and around inner areas of the intake valves 7 irrespective of the fuel injection timing, making formation of the non-stratified mixture in the combustion chamber 4 difficult.

Accordingly, it is preferable that an amount of droplets as much as possible be suspended around the surfaces of the intake valves 7, for the sake of efficiently exerting an effect that forms stratified mixture around the spark plug 10 by performing intake before the fuel droplets suspended around the inner surfaces of the intake valves 7 have dispersed and an effect that forms non-stratified mixture in the combustion chamber 4 by performing intake after the fuel droplets suspended around the inner surfaces of the intake valves 7 have been dispersed over the entire intake valves 7.

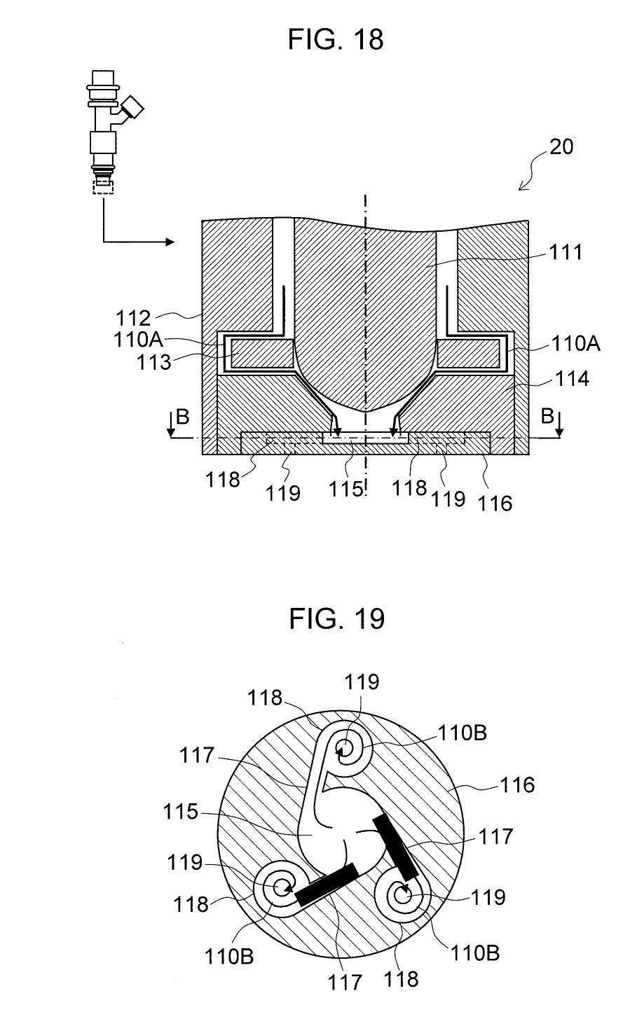

Adhesion properties of injected sprayed fuel to the wall surface are represented by a Stokes number St defined by Expression (1)

$$\begin{matrix}[ Expression 1 ] & \\ St = \frac{{ρ}_{p} {d}_{p}^{2} {V}_{p}}{18 {μ}_{g} L} & ( 1 )\end{matrix}$$

where ρ_{P} is a droplet density, and d_{P} is the Sauter mean diameter of sprayed fuel, V_{P} is average injection velocity in the droplet injection axis (=injected flow rate per unit time/nozzle area), μ_{g} is an air viscosity coefficient at atmospheric pressure at an ordinary temperature, and L is a length from the nozzle tip of the fuel injection valve 20 to the surface of the intake valve 7. The Sauter mean diameter d_{P} is a particle diameter when split of the liquid film formed at the nozzle (see FIG. 18) of the fuel injection valve 20 is completed, and the Sauter mean diameter 20 to 30 mm below the nozzle of the fuel injection valve 20. That is, the Stokes number St defined by the above Expression (1) is a dimensionless number representing a magnitude of inertial force of a droplet.

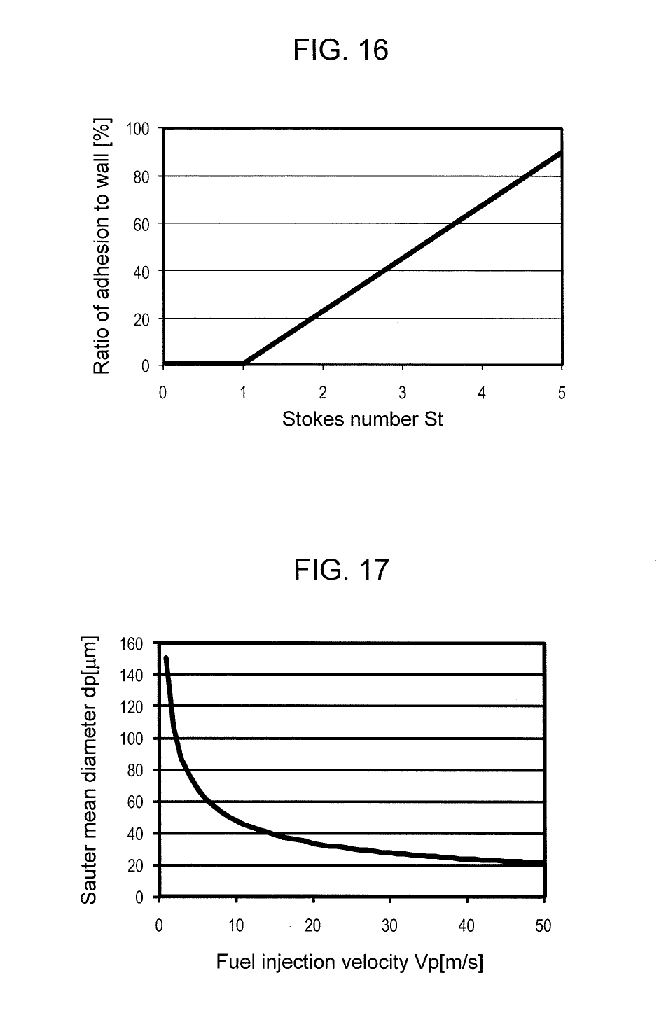

FIG. 16 shows a relationship between the Stokes number St and the wall surface adhesion ratio of sprayed fuel (=wall surface adhesion amount of fuel/fuel injection rate). This result is acquired by calculating motions of fuel droplets injected into a stationary space at ordinary temperatures and at atmospheric pressure using numerical fluid dynamics simulation, and an amount of adhesion of the droplets to the flat wall surface disposed below the nozzle port; the Stokes number St is changed by variously changing the Sauter mean diameter d_{P}, injection velocity V_{P} of the sprayed fuel and the length L from the injection point to the wall surface. As shown in the diagram, it is found out that the wall surface adhesion ratio of fuel decreases with Stokes number St (decrease in inertial forces of droplets) according to the calculation, and the adhesion to the wall surface becomes substantially zero when the Stokes number St becomes one or less. Accordingly, in order to efficiently acquire the effects by this Embodiment 1, it is preferable to set the velocity of sprayed fuel injected from the fuel injection valve 20, the particle diameters, and the lengths between the fuel injection valve 20 and the intake valve 7 such that the Stokes number St represented by Expression (1) becomes one or less.

In order to make the Stokes number St one or less, as apparent from Expression (1), it is required to form sprayed fuel with small particle diameters and fuel injection velocities. For instance, provided that the droplet density ρ_{P} is 750 kg/m³ (gasoline), the length L between the nozzle tip of the fuel injection valve 20 and the surface of the intake valve 7 is 50 mm, and air viscosity coefficient μ_{g} is 19 μPas (1 atom pressure, 300K), a relationship between the fuel injection velocity V_{P} and the Sauter mean diameter d_{P} in which Stokes number St=1 is shown in FIG. 17. Typically, the pressure of fuel supplied to the fuel injection valve used for a spark injection and port injection internal combustion engine is about three atmospheres, and the injection velocity of sprayed fuel is about 20 to 30 m/s. Accordingly, in order to make the Stokes number St one or less with this fuel injection velocity, the Sauter mean diameter d_{P} is required to be approximately 30 μm or less as shown in FIG. 17. However, the Sauter mean diameter d_{P} of a single hole swirl valve or a multi-hole valve (multi-hole injector), which is typically used as a fuel injection valve of a spark ignition and port injection internal combustion engine is about 50 to 100 μm at a fuel pressure of three atmospheres. Accordingly, in this Embodiment 1, for instance, in order to make the Stokes number St one or less, it is preferable to use fuel injection valve having a high granulation performance. In general, the particle diameter can be reduced by increasing the fuel pressure supplied to the fuel injection valve. However, as apparent from FIG. 17, if the fuel injection velocity is increased, the particle diameter of fuel is required to be further reduced in order to make the Stokes number St one or less. There is also a problem in that increase in fuel pressure increases the cost accordingly.

Thus, referring to FIGS. 18 and 19, an exemplary embodiment of a fuel injection valve suitable for this Embodiment 1 which is capable of forming sprayed fuel with fine particle diameters at a relatively low fuel pressure will be described.

FIG. 18 is a longitudinal sectional view showing a shape of the nozzle tip of the fuel injection valve 20. In this diagram, reference numeral 112 denotes a nozzle pipe. Reference numeral 114 denotes a sheet member. Reference numeral 111 denotes a valve body. Reference numeral 113 denotes a guide member. Reference numeral 116 denotes an orifice plate. Here, the valve body 111 is always pressed against the sheet member 114 by a spring mechanism, not shown. During fuel injection, the valve body 111 is pulled up by a magnetic drive mechanism, not shown, and pressurized fuel passes through an aperture between the valve body 111 and the sheet member 114 and flows into a fuel intake port 115 provided at the orifice plate 116, as indicated by arrows 110A. The fuel flowing into the fuel intake port 115 enters swirling chambers 118 and subsequently injected from nozzle ports 119.

FIG. 19 is a B-B arrow view of FIG. 18. Referring to this diagram, the flow of fuel entering the fuel intake port 115 provided at the orifice plate 116 will be described. The fuel entering the fuel intake port 115 having a substantially circular shape in sectional view passes through three fuel paths 117 provided in the directions of normals of the fuel intake port 115, and enters the swirling chambers 118 which communicate with the respective fuel paths 117. Since the fuel paths 117 are oriented in tangential directions of the outer walls of the swirling chambers 118, the flows of fuel entering the swirling chambers 118 are injected from the respective nozzle ports 119, while being swirled. It is preferable that the orifice plate 116 be provided with the plurality of nozzle ports 119 as described above and swirled flows of fuel be injected from the respective nozzle ports 119. The numbers of the fuel paths 117, swirling chambers 118 and nozzle ports 119 and the shapes of the fuel intake port 115 and the like are not limited to those in the above exemplary embodiment.

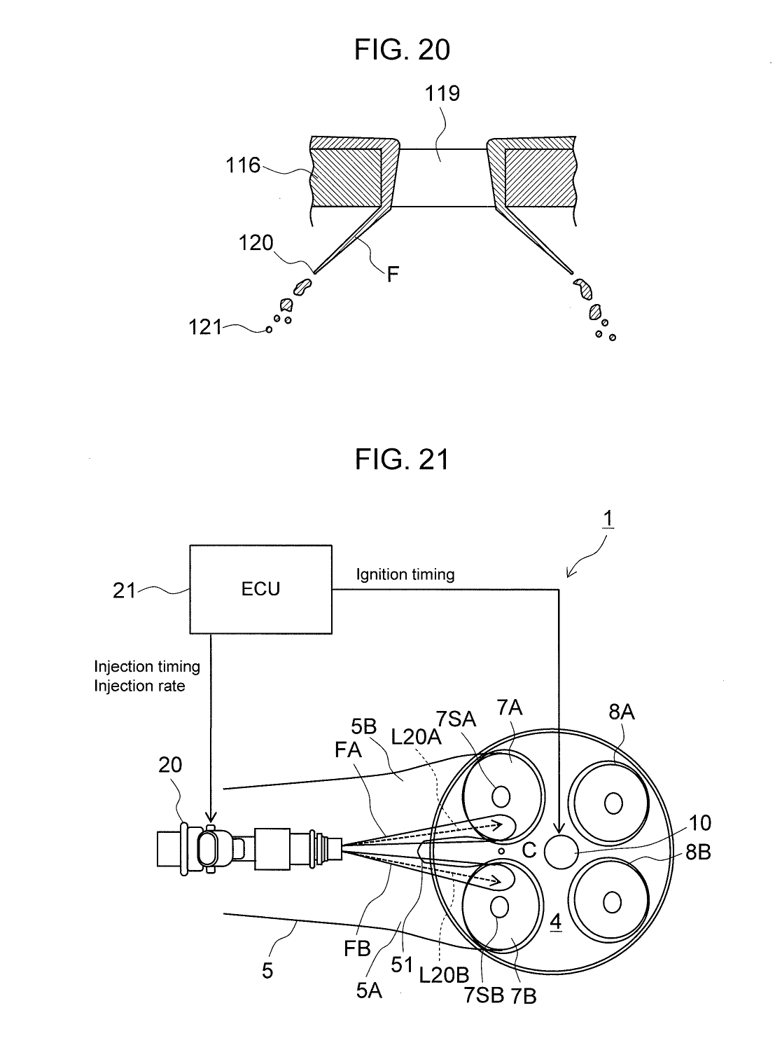

Next, FIG. 20 is a longitudinal sectional view showing a mode of a liquid film injected from the nozzle port 119 shown in FIG. 19. As described above, the flow of fuel F swirled along the inner surface of the nozzle port 119 are discharged, thereby forming a liquid film 120 having a hollow conical shape at the outlet of the nozzle port 119 by means of the centrifugal force. The liquid film 120 becomes thinner in thickness as approaching the distal end (i.e. as being apart from the nozzle port 119), and then is split to form fine droplets 121. Thus, the thin liquid film is formed in proximity to the nozzle port 119 by swirling the fuel to be injected from the nozzle port, thereby allowing the fuel to be transformed into fine particles. This enables sprayed fuel with fine particle diameters to be generated at a relatively low fuel pressure. Further, since the plurality of nozzle ports are provided, the fuel flow rate for each nozzle port can be reduced. The liquid film having a thickness thinner than that of a case of providing a single nozzle port can be formed at each of the nozzle ports. This facilitates transformation of fuel into fine particles. Moreover, the fuel is spreadingly injected in the directions of the radii of the nozzle ports by swirling. This reduces the velocity of the sprayed fuel in the injection direction (axial direction of the nozzle port), thereby forming spray having a weak penetration force in the axial direction. Thus, use of the fuel injection valve 20 suitable for this Embodiment 1 can realize spray which has fine particle diameters and low velocity in the axial direction. The Stokes number St can easily be made to be one or less, thereby enabling adhesion of fuel to the wall surface to be effectively avoided.

### Embodiment 2

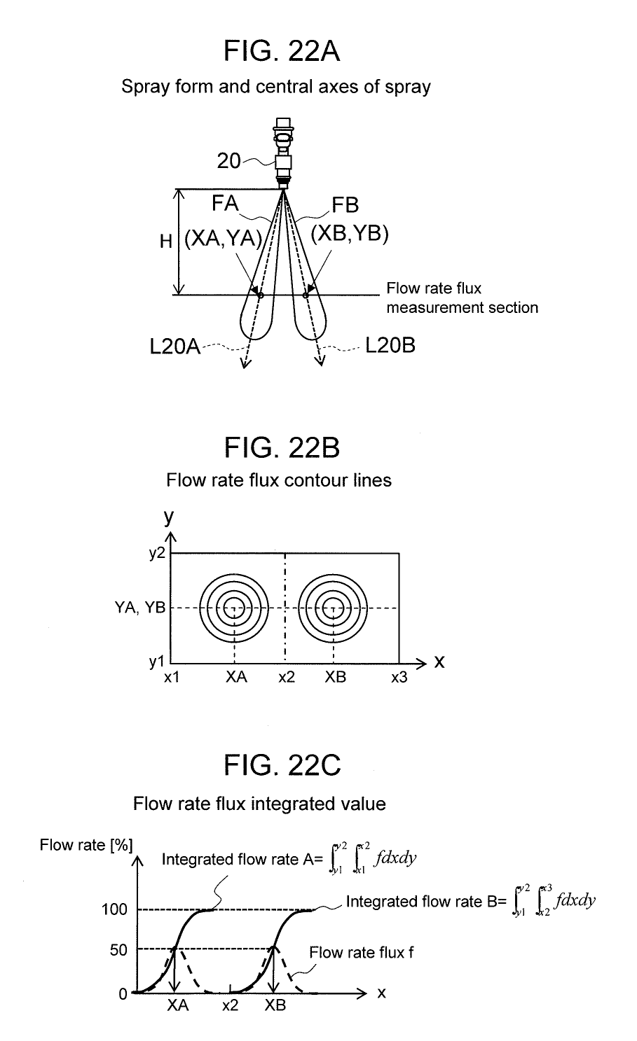

Next, referring to FIGS. 21 and 22, Embodiment 2 of a control device for an internal combustion engine according to the present invention will be described in detail. In this diagram, components substantially identical to those in Embodiment 1 are assigned with the identical symbols.

The above Embodiment 1 is the embodiment in which two fuel injection valves 20 are employed for each one of a single or plurality of cylinders 11 included in the internal combustion engine 1. In contrast, as shown in FIG. 21, Embodiment 2 is an embodiment in which a single fuel injection valve 20 is employed for one of a single of a plurality of cylinders 11 included in the internal combustion engine 1. As shown in the diagram, in Embodiment 2, a single fuel injection valve 20 is provided at a substantially center part of the intake port 5 where branched intake ports (intake paths) 5A and 5B are integrated at an upstream part. Sprayed fuel FA and FB is injected in two directions from the fuel injection valve 20. That is, from the fuel injection valve 20, the cone of sprayed fuel FA is injected toward the intake valve 7A, and the cone of sprayed fuel FB is injected toward the intake valve 7B. Here, the central axis (injection direction) L20A of the sprayed fuel FA is shifted from the center of the intake valve 7A (the center of the intake valve stem 7SA) toward the midpoint C between the two intake valves 7A and 7B. The central axis (injection direction) L20B of the sprayed fuel FB is shifted from the center of the intake valve 7B (the center of the intake valve stem 7SB) toward the midpoint C between the two intake valves 7A and 7B. The injection timing and the fuel injection rate of the fuel injection valve 20 and the fuel ignition timing by the spark plug 10 in the combustion chamber 4 are controlled by the ECU 21.

FIG. 22 is a diagram illustrating the spray forms shown in FIG. 21. FIG. 22A is a diagram illustrating definitions of the central axes L20A and L20B of the cones of the sprayed fuel FA and FB. FIG. 22B is a contour map specifically illustrating a distribution of the flow rate flux of the sprayed fuel on a section apart from the nozzle tip of the fuel injection valve 20 by a length H (e.g. 50 mm). FIG. 22C is a diagram illustrating integration of the flow rate flux shown in FIG. 22B. The fuel rate flux distribution shown in FIG. 22B is measured by, for instance, a phase Doppler particle analyzer (PDPA), a capturing sheet method or the like.

As shown in FIG. 22A, first, it is provided that spray centers of the cones of sprayed fuel FA and FB on a section apart from the nozzle tip of the fuel injection valve 20 by the length H (e.g. 50 mm) are (XA, YA) and (XB, YB), respectively. Further, an axis connecting the center of the fuel injection valve 20 and spray center coordinates (XA, YA) is defined as the central axis L20A of the cone of sprayed fuel FA, and an axis connecting the center of the fuel injection valve 20 and spray center coordinates (XB, YB) is defined as the central axis L20B of the cone of sprayed fuel FB.

Next, as shown in FIG. 22B, provided that a measurement section for the flow rate flux distribution is X-Y plane, a flow rate flux distribution can be acquired where, for instance, local maximum values of flow rates are reached at the centers of the cones of sprayed fuel FA and FB and the flow rates decrease from the center toward the outside in the radial directions.

FIG. 22C shows a result of integration of the flow rate flux over the X axis shown in FIG. 22B. Since the fuel injection valve 20 used in this Embodiment 2 injects the cones of sprayed fuel FA and FB in the two directions, flow rates are integrated on the cones of the sprayed fuel FA and FB, respectively, in FIG. 22C. In this Embodiment 2, X coordinates XA and XB where the integrated flow rates become 50% of total integrated flow rates are the center of the cones of sprayed fuel FA and FB, respectively, in the X direction. Also in the Y direction, central coordinates YA and YB of the respective cones of sprayed fuel FA and FB can be acquired. That is, the acquired coordinates (XA, YA) represent barycentric coordinates of the sprayed fuel FA in the measurement section, and the coordinates (XB, YB) represent barycentric coordinates of the sprayed fuel FB in the measurement section.

Thus, the cones of sprayed fuel FA and FB are injected from the single fuel injection valve 20 in the two directions toward the inner areas of the intake valves 7A and 7B, respectively, and the fuel injection end timing of the fuel injection valve 20 is changed. This allows formation of the stratified mixture and the non-stratified mixture to be easily switched according to operation conditions, as with Embodiment 1.

### Embodiment 3

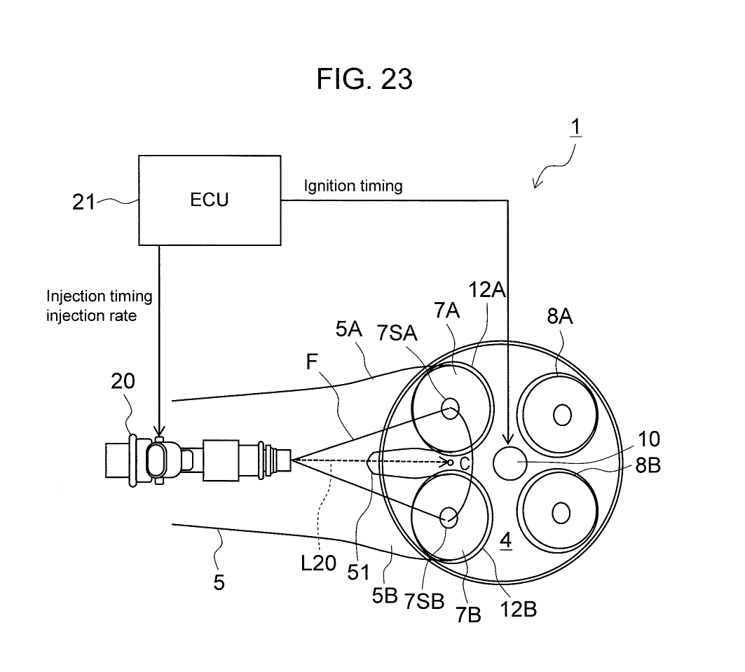

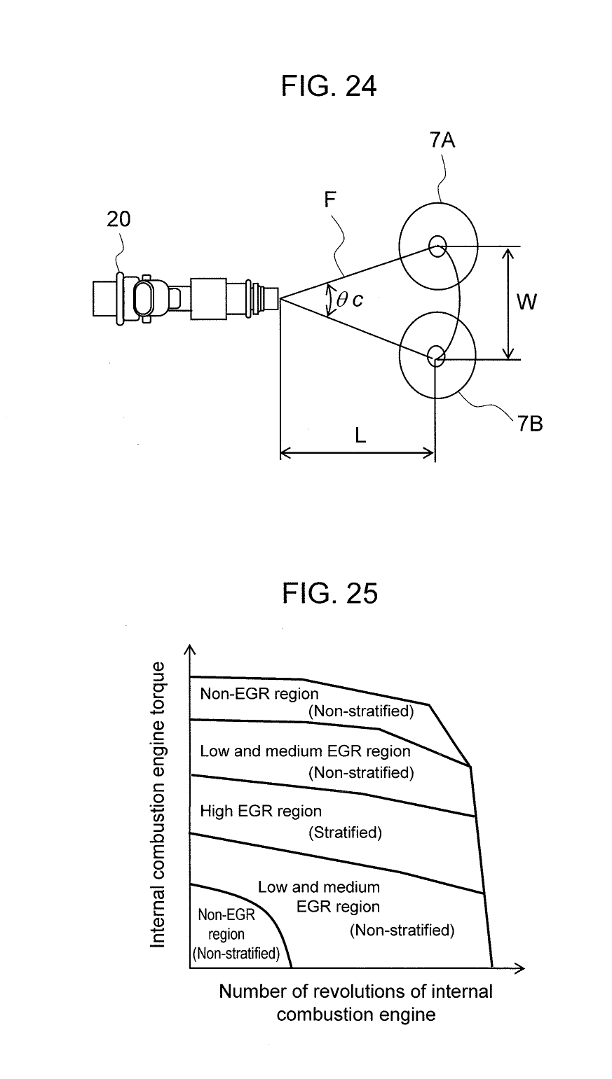

Next, referring to FIGS. 23 and 24, Embodiment 3 of a control device for an internal combustion engine according to the present invention will be described in detail. In this diagram, components substantially identical to those in Embodiments 1 and 2 are assigned with the identical symbols.

FIG. 23 shows another embodiment, or Embodiment 3, which employs a single fuel injection valve 20 for each one of a single or plurality of cylinders 11 included in the internal combustion engine 1. In this Embodiment 3, the sprayed fuel F is injected in a single direction so as to inject fuel from the fuel injection valve 20 toward two intake valves 7A and 7B. Here, the central axis (injection direction) L20 of the sprayed fuel F is oriented toward the midpoint C of the line segment connecting the center of the intake valve 7A (center of the intake valve stem 7SA) and the center of the intake valve 7B (center of the intake valve stem 7SB). The position of the sprayed fuel F and the spray cone angle are defined such that the sprayed fuel width W (see FIG. 24) at the positions of the intake valves 7A and 7B is substantially equals to the separation between the two intake valves 7A and 7B. The sprayed fuel F injected from the fuel injection valve 20 disposed at the intake port 5 is branched at a branch part 51 into the two branched intake ports (intake paths) 5A and 5B, supplied to inner areas inside the intake valves 7A and 7B, and, when the intake valves 7A and 7B are open, flows into the combustion chamber 4 through the intake openings 12A and 12B. The injection timing and the fuel injection rate of the fuel injection valve 20, and the fuel ignition timing by the spark plug 10 in the combustion chamber 4 are controlled by the ECU 21.

As shown in FIG. 24, provided that L is a length from the nozzle tip of the fuel injection valve 20 to the intake valves 7A and 7B and W is a separation between the centers of the two intake valves 7A and 7B, the spray cone angle θc may approximately be defined so as to be an angle given by the Expression (2).

$$\begin{matrix}[ Expression 2 ] & \\ {θ}_{C} = 2 {tan}^{- 1} ( \frac{W}{2 L} ) & ( 2 )\end{matrix}$$

Thus, the cone of the sprayed fuel F is injected from the single fuel injection valve 20 in the single direction toward the inner areas of the intake valves 7A and 7B, respectively, and the fuel injection end timing of the fuel injection valve 20 is changed. This allows formation of the stratified mixture and formation of the non-stratified mixture to be easily switched responsive to operation conditions, as with Embodiments 1 and 2.

In Embodiments 2 and 3, the number of fuel injection valves 20 per cylinder 11 is one. This allows the cost to be reduced, and enables the space for attaching the fuel injection valve 20 to be suppressed. Meanwhile, the fuel F is injected from the single fuel injection valve 20 toward the inner areas of the two intake valves 7A and 7B. This causes a possibility that the sprayed fuel F collides with the branch part 51 of the intake port 5 and forms a flow on the wall. In contrast, in Embodiment 1, use of the two fuel injection valve 20 per cylinder 11 allows the fuel F to be injected toward the inner areas of the intake valves 7A and 7B from a position more apart from the branch part 51 of the intake port 5 than that of Embodiments 2 and 3. This suppresses the sprayed fuel from colliding with the branch part 51 to form a flow on the wall, thereby allowing a lot of fuel droplets to be suspended in the intake port 5.

The above Embodiment 1 describes an embodiment of switching between the stratified operation and the non-stratified operation specifically in the warm-up mode and the mode after the warm-up mode. However, switching between the stratified mixture and the non-stratified mixture is not limited in the warm-up mode and the mode after the warm-up mode, but is also required in for instance a case of performing exhaust gas recirculation (EGR). In a spark-ignition internal combustion engine, in certain cases, EGR operation that recirculates a part of exhaust back into combustion chamber is performed in order to reduce pump loss and emission of nitrogen oxides (NOx). For the sake of reducing pump loss and emission of NOx, it is preferable to recirculate exhaust back into the combustion chamber as much as possible and to operate the internal combustion engine at a high EGR rate (the mass of the exhaust gas in the combustion chamber/the total mass of the gas in the combustion chamber). However, if the EGR rate is increased, a dilution effect reduces the initial flame propagation velocity. This causes a tendency of instability in fuel combustion. Thus, in a case of a high EGR rate, it can be considered that the stratified mixture is formed to increase the fuel density around the spark plug, and the initial flame propagation velocity is improved to stabilize fuel combustion. On the other hand, in a case where the EGR rate is low and the fuel combustion is stabilized, it can be considered that the non-stratified mixture is formed and air and fuel are well mixed, thereby improving combustion efficiency.

### Embodiment 4

Thus, referring to FIGS. 25 to 31, Embodiment 4 in which a control device for an internal combustion engine according to the present invention is applied to EGR operation will be described in detail. In this Embodiment 4, the description is made using the internal combustion engine 1 including components substantially identical to those in Embodiment 1 shown in FIGS. 1 to 3. However, instead of Embodiment 1, Embodiments 2 and 3 may be applicable. Also in this Embodiment 4, components substantially identical to those in Embodiment 1 are assigned with the identical symbols and described.

As described with reference to FIG. 1, in the internal combustion engine 1, a part of exhaust is recirculated back into the intake port 5 through the EGR tube 28 and taken into the combustion chamber 4 of the cylinder 11 together with the fresh air. Here, the EGR rate is determined according to the degree of opening of the EGR valve 29 and the degree of opening of the throttle valve 26. For instance, increase in the degree of opening of the EGR valve 29 and decrease in the degree of opening of the throttle valve 26 allow more exhaust gas to be taken into the combustion chamber 4 and also enable the EGR rate (the mass of the exhaust gas in the combustion chamber/the total mass of the gas in the combustion chamber) to be increased. The degree of opening of the throttle valve 26 and the degree of opening of the EGR valve 29 are defined by instructions from the ECU 21.

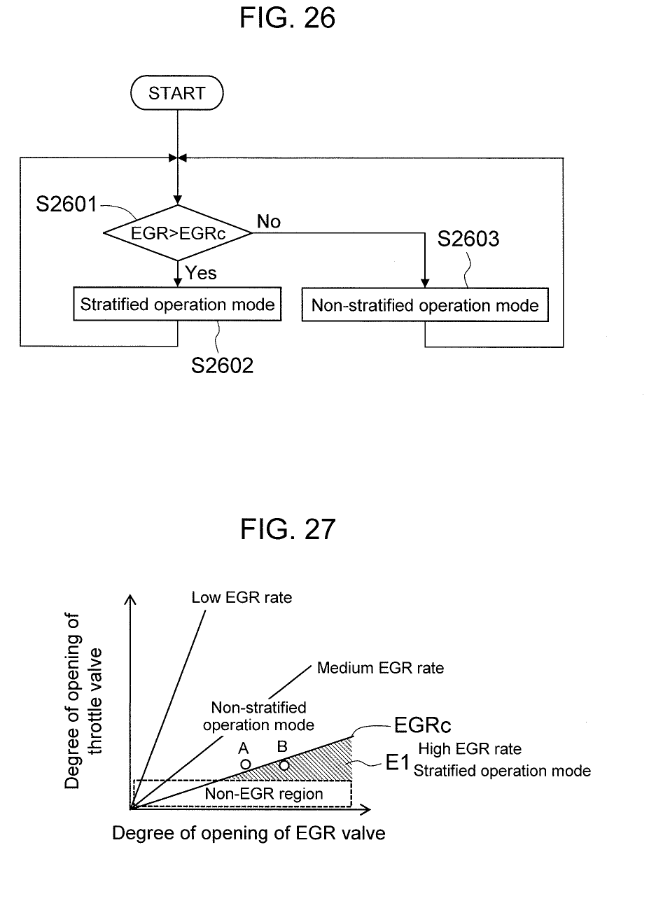

FIG. 25 shows a setting map of the number of revolutions and EGR rates for torques in the internal combustion engine 1 in this Embodiment 4. The EGR rate is predetermined in consideration of the fuel consumption, exhaust, output, operability (cycle variation) and the like of the internal combustion engine 1; when the ECU 21 determines the degree of opening of the throttle valve 26 and the degree of opening of the EGR valve 29 responsive to a load on internal combustion engine and the number of revolutions, the predetermined EGR rate is set according to the map shown in FIG. 25. Here, as shown in the diagram, in the non-EGR region or the low and medium EGR regions, the internal combustion engine 1 is operated in the non-stratified mixture mode. In the high EGR region, the internal combustion engine 1 is operated in the stratified mixture mode in order to solve instability in combustion. That is, in this Embodiment 4, as shown in FIG. 26, if the ECU 21 determines that the EGR rate set responsive to the present number of revolutions and torque is larger than the predetermined EGR rate (EGRc) (S2601), the internal combustion engine 1 is operated in the stratified operation mode (S2602). If it is determined that the rate is smaller than EGRc (S2601), the internal combustion engine 1 is operated in the non-stratified operation mode (S2603).

FIG. 27 shows variation in EGR rate according to the degree of opening of the EGR valve 29 and the degree of opening of the throttle valve 26 in this Embodiment 4. As described above, the EGR rate increases with increase in degree of opening of the EGR valve 29 and with decrease in degree of opening of the throttle valve 26. Accordingly, in FIG. 27, the EGR rate increases from the top left to the right bottom. In a region El shown in the diagram, since the EGR rate is higher than the EGRc, the internal combustion engine 1 is operated in the stratified operation mode. In regions other than the region El, since the EGR rate is lower than EGRc, the engine is operated in the non-stratified operation mode. When the degree of opening of the throttle valve 26 is smaller than a prescribed degree of opening, the mode is always set to non-EGR region and the engine is operated in the non-stratified operation mode irrespective of the degree of opening of the EGR valve 29.

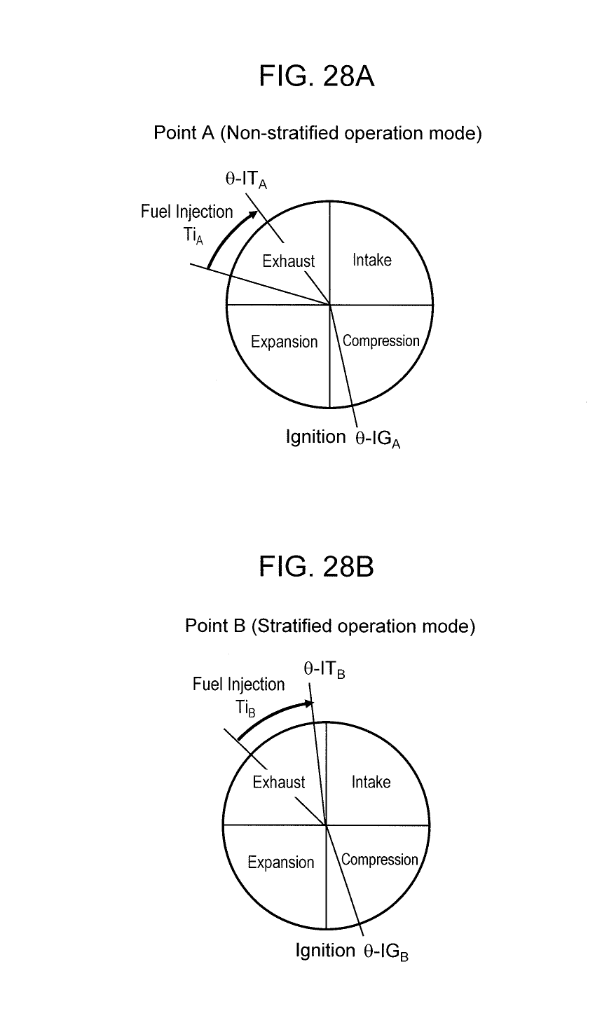

Here, referring to FIG. 28, the fuel injection control at points A and B shown in FIG. 27 will be described. At the points A and B, the degree of opening of the throttle valve 26 is constant, while the degree of opening of the EGR valve 29 at the point B is larger. The rate is the medium EGR rate (EGR rate<EGRc) at the point A, and the rate is the high EGR rate (EGR rate>EGRc) at the point B. Accordingly, the internal combustion engine 1 is operated, in the non-stratified operation mode at the point A, and in the stratified operation mode at the point B.

As shown in FIG. 28A, at the point A where the internal combustion engine 1 is operated in the non-stratified operation mode, the injection end timing θ-IT_{A} of the fuel injection valve 20 is set sufficiently before the intake top dead center (e.g., ca. 90° before the intake top dead center). The ignition timing θ-IG_{A} is set in the latter part of the compression stroke (e.g., ca. 20° before the compression top dead center). Thus, at the point A, the injection end timing θ-IT_{A} of the fuel injection valve 20 is set sufficiently before the intake top dead center, and intake is made after the fuel droplets suspended around the inner surfaces of the intake valves 7 have been distributed over the entire intake valves 7. This allows non-stratified mixture to be formed in the combustion chamber 4.

On the other hand, as shown in FIG. 28B, at the point B where the internal combustion engine 1 is operated in the stratified operation mode, the injection end timing θ-IT_{B} is retarded from the injection end timing θ-IT_{A} at the point A, and set in the latter part of the exhaust stroke (e.g., ca. 10° before the intake top dead center). The ignition timing θ-IG_{B} is set so as to be equivalent to that at the point A or a little advanced timing (e.g., ca. 25° before the compression top dead center). Here, the ignition timing θ-IG_{B} at the point B is a little advanced from the ignition timing θ-IG_{A} at the point A. This can correct increase in EGR rate at the point B and resultant decrease in combustion speed and resultant retard in heat generation timing. Thus, at the point B, the injection end timing θ-IT_{B} of the fuel injection valve 20 is in the latter part of the exhaust stroke, and intake is made before the fuel droplets suspended around the inner surfaces of the intake valves 7 have dispersed over the entire intake valves 7. This allows stratified mixture to be formed in the combustion chamber 4.

At the points A and B, since the degrees of opening of the throttle valve 26 is constant, flow rates of fresh air flowing into the combustion chamber 4 are equivalent to each other. Accordingly, fuel injection rates at the points A and B are substantially equivalent to each other. Between the fuel injection time Ti_{A} at the point A and the fuel injection time Ti_{B} at the point B, a relationship that Ti_{A}≈T_{B} holds.

Thus, when the EGR rate is higher than the specified value, the internal combustion engine 1 is operated in the stratified operation mode. This allows instability in combustion at a high EGR rate to be reduced. When the EGR rate is lower than the specified value, the internal combustion engine 1 is operated in the non-stratified mode. This allows air and fuel to be mixed well, thereby enabling combustion efficiency to be improved.

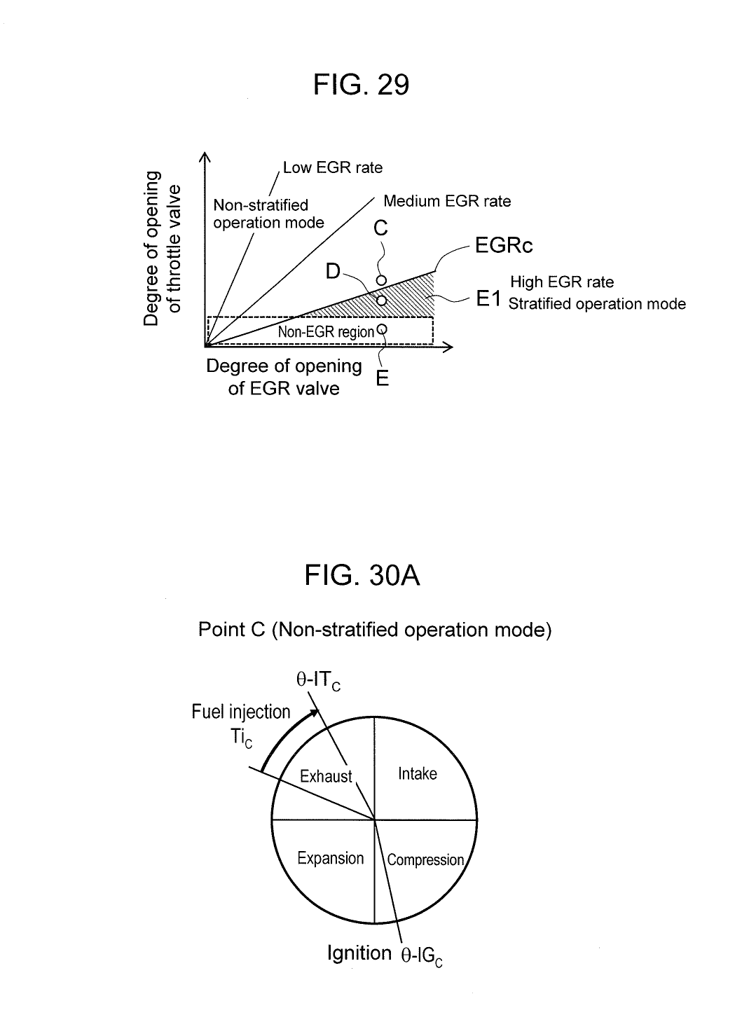

Next, fuel injection control at points C, D and E on a map of the degree of opening of the throttle valve 26 and the degree of opening of the EGR valve 29 shown in FIG. 29 will be described. The map itself shown in this diagram is identical to that of FIG. 27. Here, at the points C, D and E, the degrees of opening of the EGR valve 29 are constant, while the degrees of opening of the throttle valve 26 have a relationship, point C>point D>point E; at the point C, the rate is the medium EGR rate (EGR rate<EGRc). At the point D, the rate is the high EGR rate (EGR rate>EGRc). Accordingly, internal combustion engine 1 is operated, in the non-stratified operation mode at the point C, and in the stratified operation mode at the point D. At the point E, as described with reference to FIG. 27, the degree of opening of the throttle valve 26 is lower than the specified value. This falls into the non-EGR region; the internal combustion engine 1 is operated in the non-stratified operation mode.

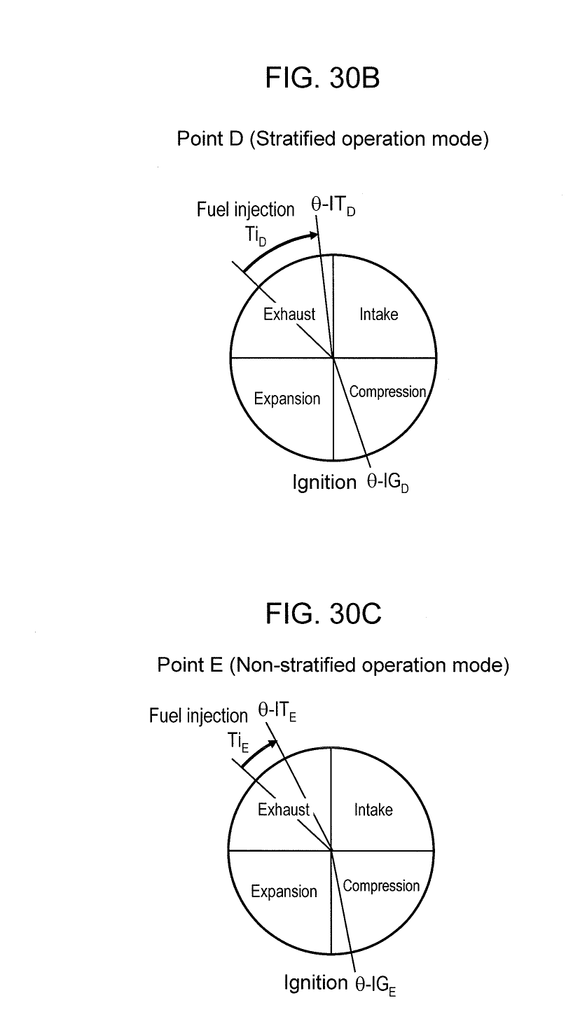

FIG. 30 shows fuel injection timings and ignition timings at the points C, D and E. As shown in FIGS. 30A and 30C, at the points C and E where the internal combustion engine 1 is operated in the non-stratified operation mode, injection end timings θ-IT_{C} and θ-IT_{E} of the fuel injection valve 20 are set sufficiently before the intake top dead center (e.g., ca. 90° before the intake top dead center). The ignition timings θ-IG_{C} and θ-IG_{E} are set in the latter part of the compression stroke (e.g., ca. 20° before the compression top dead center). Thus, at the points C and E, the injection end timings θ-IT_{C} and θ-IT_{E} of the fuel injection valve 20 are sufficiently set before intake top dead center, and intake is made after the fuel droplets suspended around the inner surfaces of the intake valves 7 have been dispersed over the entire intake valves 7. This allows non-stratified mixture to be formed in the combustion chamber 4.

On the other hand, as shown in FIG. 30B, at the point D where the internal combustion engine 1 is operated in the stratified operation mode, the injection end timing θ-IT_{D} of the fuel injection valve 20 is retarded from the injection end timings θ-IT_{C} and θ-IT_{E} at the respective points C and E where the internal combustion engine 1 is operated in the non-stratified operation mode, and set in the latter part of the exhaust stroke (e.g., ca. 10° before the intake top dead center). The ignition timing θ-IG_{D} is set so as to be equivalent to that the ignition timing θ-IG_{C} at the point C or a little advanced timing (e.g., ca. 25° before the compression top dead center). Here, the ignition timing θ-IG_{D} at the point D is a little advanced from the ignition timing θ-IG_{C} at the point C. This can correct increase in EGR rate at the point D and resultant decrease in combustion speed and resultant retard in heat generation timing. Thus, at the point D, the injection end timing θ-IT_{D} of the fuel injection valve 20 is in the latter part of the exhaust stroke, and intake is made before the fuel droplets suspended around the inner surfaces of the intake valves 7 have dispersed over the entire intake valves 7. This allows stratified mixture to be formed in the combustion chamber 4.

The degrees of opening of the throttle valve 26 have a relationship, point C>point D>point E. Accordingly, a relationship, Ti_{C}>Ti_{D}>Ti_{E}, holds among the fuel injection time Ti_{C} at the point C, the fuel injection time Ti_{D} at the point D and the fuel injection time Ti_{E} at the point E.

Thus, when the EGR rate is higher than the specified value, the internal combustion engine 1 is operated in the stratified operation mode. This allows instability in combustion at a high EGR rate to be reduced. When the EGR rate is lower than the specified value, the internal combustion engine 1 is operated in the non-stratified mode. This allows air and fuel to be mixed well, thereby enabling combustion efficiency to be improved.

As described above, in these Embodiments 1 to 4, in the warm-up mode, intake is made before the fuel droplets suspended around the inner surfaces of the intake valves 7 have been dispersed. This allows stratified mixture to be formed around the spark plug 10 of the combustion chamber 4. On the other hand, after the end of the warm-up mode, intake is made after the fuel droplets suspended around the inner surfaces of the intake valves 7 have been dispersed over the intake valves 7. This allows non-stratified mixture to be formed in the combustion chamber 4. That is, in these Embodiments 1 to 4, the sprayed fuel distribution in the intake port 5 before the intake top dead center effects formation of mixture thereafter.

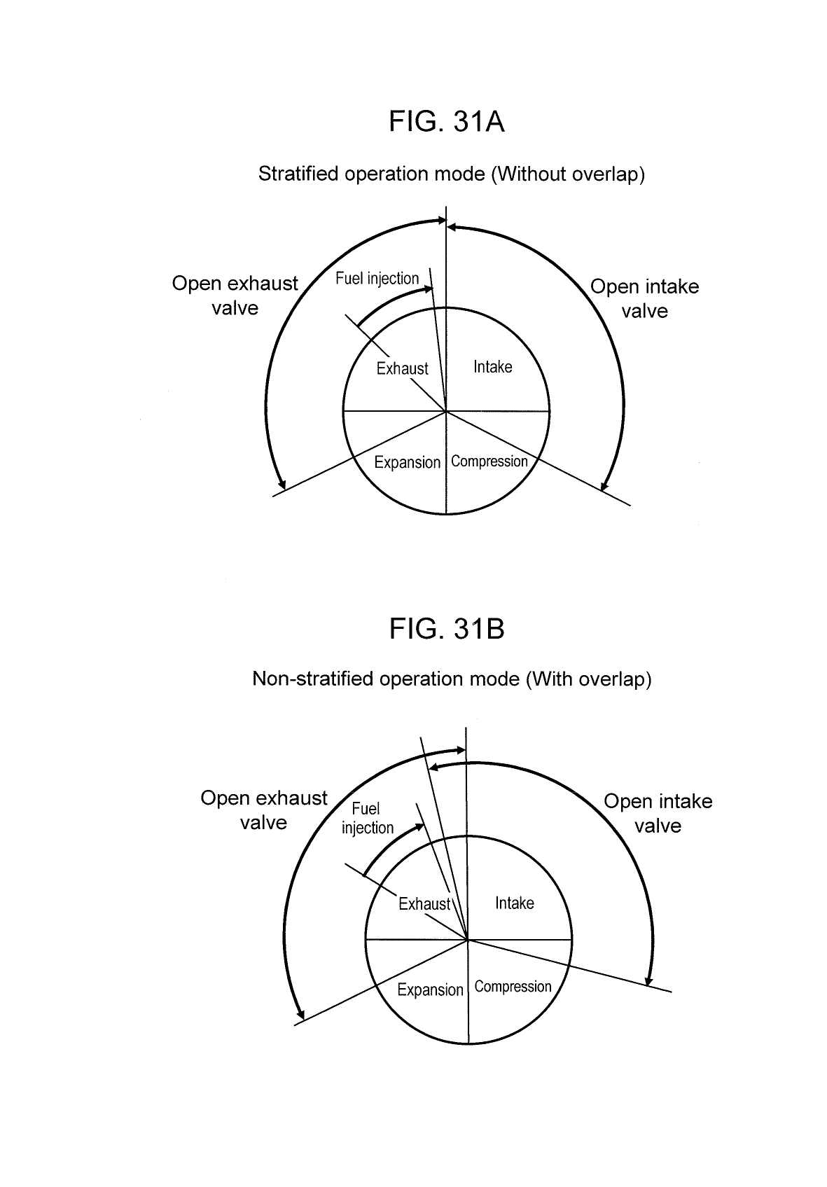

Incidentally, motion of sprayed fuel in the intake port 5 is changed according to opening and closing timings of the intake valves 7 and the exhaust valves 8. Thus, optimal opening and closing timings of the intake valves 7 and the exhaust valves 8 in these Embodiments 1 to 4 will be described with reference to FIG. 31.

FIG. 31 A shows opening and closing timings of the intake valves 7 and the exhaust valves 8 which are suitable for the stratified operation mode. In the stratified operation mode, it is preferable to set the valve opening timing of the intake valves 7 after the valve closing timing of the exhaust valves 8. That is, it is preferable that the valve opening time of the intake valves 7 and the valve opening time of the exhaust valves 8 not overlap with each other. In the case where the valve opening timing of the intake valves 7 is after the valve closing timing of the exhaust valves 8, the combustion gas in the combustion chamber 4 is not blown back into the intake port 5 including the branched intake ports 5A and 5B. This can prevent the sprayed fuel F injected toward the inner areas of the two intake valves 7A and 7B from being dispersed into the intake port 5 including the branched intake ports 5A and 5B by means of blowback gas.

FIG. 31 B shows opening and closing timings of the intake valves 7 and the exhaust valves 8 which are suitable for the non-stratified operation mode. In the non-stratified mode, it is preferable to set the valve opening timing of the intake valve 7 to be advanced from the valve closing timing of the exhaust valve 8. That is, it is preferable that the valve opening time of the intake valves 7 and the valve opening time of the exhaust valves 8 overlap with each other. In the case where the valve opening timing of the intake valves 7 is advanced from the valve closing timing of the exhaust valve 8, the combustion gas in the combustion chamber 4 is blown back into the intake port 5 including the branched intake ports 5A and 5B. This can facilitate dispersion and vaporization of fuel in the intake port 5 including the branched intake ports 5A and 5B by means of the blowback gas.

The four embodiments of the present invention have thus been described above. However, the present invention is not limited to the embodiments. Instead, various modification of design can be made without departing from the spirit of the invention as defined in the claims.

As can be understood by the above description, according to Embodiments 1 to 4, setting of the fuel injection end timing in the latter part of the exhaust stroke allows fuel-rich stratified mixture to be formed around the spark plug. This can suppress cycle variation of combustion to be caused in the operation in the warm-up mode immediate after cold start-up or at high EGR rate. Accordingly, the ignition retard amount can be increased in warming-up operation, and catalyst activation time is reduced, thereby allowing emission of unburned HC to be reduced. Further, since the EGR rate can be increased, the pump loss is reduced to thereby allow fuel consumption efficiency to be improved. Moreover, the fuel injection end timing is more advanced than that in the stratified operation mode, thereby enabling fuel to be dispersed in the combustion chamber. Accordingly, air and fuel are mixed well, thereby allowing combustion efficiency to be improved. Thus, only by orienting the fuel injection directions toward inner areas of the intake valves and changing the fuel injection timing, the stratified operation mode and the non-stratified operation mode can easily be switched to each other. This allows the configuration of the device and the control method to be simplified.

The present invention is not limited to the above Embodiments 1 to 4. Instead, various modifications are included therein. For instance, the above Embodiments 1 to 4 are detailed description for the sake of easy understanding of the present invention. These embodiments do not necessarily limit the invention to those which include the entire configuration having been described. Configurational components of a certain embodiment can replace those of another embodiment. A certain embodiment can further include configurational components of another embodiment. A part of the configurations of Embodiments 1 to 4 can be subjected to addition, deletion and replacement using another configuration.

The control lines and information lines considered to be required are shown; not all the control lines and information lines are necessarily shown. In actuality, it can be considered that almost all the configurational components are connected to each other.

### DESCRIPTION OF SYMBOLS

1 . . . internal combustion engine, 2 . . . cylinder block, 3 . . . piston, 4 . . . combustion chamber, 5 . . . intake port, 5A and 5B . . . branched intake ports (intake paths), 6 . . . exhaust port, 7, 7A and 7B . . . intake valves, 7SA and 7SB . . . intake valve stems, 8, 8A and 8B . . . exhaust valves, 9 . . . cylinder head, 10 . . . spark plug, 11 . . . cylinder, 12, 12A and 12B . . . intake openings, 13, 13A and 13B . . . exhaust openings, 20, 20A and 20B . . . fuel injection valves, 21 . . . ECU (internal combustion engine control unit), 23. . .catalytic converter, 24 . . . catalyst temperature sensor, 25 . . . coolant temperature sensor, 26 . . . throttle valve, 27. . . air flow meter, 28 . . . EGR tube, 29 . . . EGR valve, 111 . . . valve body, 112 . . . nozzle pipe, 113 . . . guide member, 114 . . . sheet member, 115 . . . fuel intake port, 116 . . . orifice plate, 117 . . . fuel path, 118 . . . swirling chamber, 119 . . . nozzle port, 120 . . . liquid film, 121 . . . droplet, C . . . midpoint of line segment connecting centers of two intake valves, d_{P} . . . Sauter mean diameter of sprayed fuel, F, FA and FB . . . sprayed fuel, L . . . length from nozzle tip of fuel injection valve to surface of intake valve, L20, L20A and L20B . . . central axes of sprayed fuel, St . . . Stokes number, Ti . . . fuel injection time, V_{P} . . . average injection velocity in injection direction, W . . . length between centers of two intake valves, θc . . . sprayed fuel cone angle, μ_{g} . . . air viscosity coefficient, and ρ_{P} . . . droplet density.

1. A control device for an internal combustion engine, the engine comprising: a cylinder including two intake openings; two intake paths which are connected to the cylinder and communicate with a combustion chamber of the cylinder through the respective two intake openings; two intake valves which are arranged in the respective two intake paths and open and close the intake openings; and at least one fuel injection valve for injecting fuel in the two intake paths,
wherein the fuel injection valve is arranged such that injection directions of injected sprayed fuel are disposed nearer a midpoint of a line segment connecting centers of the two intake valves than the centers of two intake valves, respectively,
the control device controls injection timing of the fuel injection valve by means of at least a stratified operation mode in which fuel injection is completed within an exhaust stroke, and a non-stratified operation mode in which the fuel injection is completed in a range from a compression stroke to the exhaust stroke, and
an injection end timing of the fuel injection valve in the stratified operation mode is more retarded than an injection end timing of the fuel injection valve in the non-stratified operation mode in which a fuel injection time of the fuel injection valve is equal to or shorter than a fuel injection time of the stratified operation mode.

2. The control device for an internal combustion engine according to claim 1, wherein the engine comprises two fuel injection valves, and injections of the fuel from the two fuel injection valves are directed into the different intake paths, respectively.

3. The control device for an internal combustion engine according to claim 1, wherein the fuel injection valve injects the sprayed fuel in two injection directions from the fuel injection valve, and injections of the sprayed fuel in the two injection directions are directed into the different intake paths, respectively.

4. The control device for an internal combustion engine according to claim 1,wherein the fuel injection valve includes an injection nozzle which injects swirling fuel from a plurality of nozzle ports included in the fuel injection valve.

5. The control device for an internal combustion engine according to claim 1,wherein a defined Stokes number St=ρd²V/(18 μL) is equal to or less than one, where an average velocity of the sprayed fuel injected from the fuel injection valve in an axial direction at a nozzle is V, a Sauter mean diameter is d, a length from the nozzle to the intake valve is L, a density of fuel in liquid is ρ, an air viscosity coefficient is μ.

6. The control device for an internal combustion engine according to claim 1,wherein if the ignition timing is at or after a compression stroke top dead center, the fuel injection valve is controlled in the stratified operation mode.

7. The control device for an internal combustion engine according to claim 1, wherein the mode is set to the stratified operation mode and the ignition timing is set at or after a compression stroke top dead center during warming-up of the internal combustion engine, and the mode is set to the non-stratified operation mode and the ignition timing is advanced from the compression stroke top dead center after an end of the warming-up of the internal combustion engine.

8. The control device for an internal combustion engine according to claim 1, wherein if at least one of a coolant temperature, an exhaust temperature and a catalyst temperature of the internal combustion engine is lower than a prescribed temperature, the mode is set to the stratified operation mode and the ignition timing is set at or after a compression stroke top dead center, and, if at least one of the coolant temperature, the exhaust temperature and the catalyst temperature of the internal combustion engine exceeds the prescribed temperature, the mode is shifted to the non-stratified operation mode and the ignition timing is advanced from the compression stroke top dead center.

9. The control device for an internal combustion engine according to claim 1, wherein at least the stratified operation mode is provided in a region where an EGR rate in the combustion chamber of the cylinder is higher than a prescribed EGR rate, and at least the non-stratified operation mode is provided in a region where the EGR rate in the combustion chamber of the cylinder is lower than the prescribed EGR rate.

10. The control device for an internal combustion engine according to claim 1, further comprising: a throttle valve arranged upstream of the two intake paths; and an EGR valve for adjusting a flow rate of exhaust gas flowing into an EGR tube connecting the two intake paths and an exhaust path in communication with each other, wherein, in a case of a constant degree of opening of the throttle valve, at least the stratified operation mode is provided in a region where a degree of opening of the EGR valve is higher than a prescribed degree of opening, and at least the non-stratified operation mode is provided in a region where the degree of opening of the EGR valve is lower than the prescribed degree of opening.

11. The control device for an internal combustion engine according to claim 1, further comprising: a throttle valve arranged upstream of the two intake paths; and an EGR valve for adjusting a flow rate of exhaust gas flowing into an EGR tube connecting the two intake paths and an exhaust path in communication with each other,
wherein, in a case of a constant degree of opening of the EGR valve, at least the stratified operation mode is provided in a region where the degree of opening of the throttle valve is lower than a prescribed degree of opening, and at least the non-stratified operation mode is provided in a region where the degree of opening of the throttle valve is higher than the prescribed degree of opening.

12. The control device for an internal combustion engine according to claim 1, wherein, in the stratified operation mode, a valve opening start timing of the intake valves is after an intake top dead center.

13. The control device for an internal combustion engine according to claim 1, wherein, in the stratified operation mode, a valve opening start timing of the intake valves is after an intake top dead center, and, in the non-stratified operation mode, the valve opening start timing of the intake valves is before the intake top dead center.

14. A control device for an internal combustion engine, the engine comprising: a cylinder including two intake openings; two intake paths which are connected to the cylinder and communicate with a combustion chamber of the cylinder through the respective two intake openings; two intake valves which are arranged in the respective two intake paths and open and close the intake openings;
and at least one fuel injection valve for injecting fuel in the two intake paths,
wherein the fuel injection valve is arranged such that injection directions of injected sprayed fuel are disposed nearer a midpoint of a line segment connecting centers of the two intake valves than the centers of two intake valves, respectively,
the control device controls injection timing of the fuel injection valve by switching an identical injection duration completing fuel injection before an intake top dead center, or an injection end timing of the fuel injection valve at an identical injection rate, between a latter part of an exhaust stroke and a timing advanced from the latter part of the exhaust stroke.

15. The control device for an internal combustion engine according to claim 14, wherein, in a case of setting the injection end timing of the fuel injection valve in the latter part of the exhaust stroke, a valve opening start timing of the intake valves is set after a valve closing timing of the exhaust valve.

16. The control device for an internal combustion engine according to claim 15, wherein, in a case of setting the injection end timing of the fuel injection valve to the timing advanced from the latter part of the exhaust stroke, a valve opening start timing of the intake valves is advanced from the valve closing timing of the exhaust valve.

17. An internal combustion engine, comprising: a cylinder including two intake openings;
two intake paths which are connected to the cylinder and communicate with a combustion chamber of the cylinder through the respective two intake openings; two intake valves which are arranged in the respective two intake paths and open and close the intake openings; and at least one fuel injection valve for injecting fuel in the two intake paths, wherein the fuel injection valve is arranged such that injection directions of injected sprayed fuel are disposed nearer a midpoint of a line segment connecting centers of the two intake valves than the centers of two intake valves, respectively.

18. The internal combustion engine according to claim 17, wherein the engine comprises two fuel injection valves, and injections of the fuel from the two fuel injection valves are directed into the different intake paths, respectively.

19. The internal combustion engine according to claim 17, wherein the fuel injection valve injects the sprayed fuel in two injection directions from the fuel injection valve, and injections of the sprayed fuel in the two injection directions are directed into the different intake paths, respectively.
